(19) United States
(12) Patent Application Publication
(10) Pub. No.: US 2024/0340122 A1
(43) Pub. Date: Oct. 10, 2024

(54) MULTIPLE ANTENNA PORT SOUNDING REFERENCE SIGNAL TRANSMISSION USING SETS OF SYMBOLS

(71) Applicant: QUALCOMM Incorporated, San Diego, CA (US)

(72) Inventors: Yi HUANG, San Diego, CA (US); Muhammad Sayed Khairy ABDELGHAFFAR, San Jose, CA (US); Mostafa KHOSHNEVISAN, San Diego, CA (US)

(21) Appl. No.: 18/586,016

(22) Filed: Feb. 23, 2024

Related U.S. Application Data
(60) Provisional application No. 63/494,733, filed on Apr. 6, 2023.

(51) Int. Cl. H04L 5/00; H04B 1/7136; H04L 27/26

(52) U.S. Cl. CPC H04L 5/0007; H04B 1/7136; H04L 27/2692

(57) ABSTRACT

Methods, systems, and devices for wireless communications are described. One or more user equipment (UEs) and network entities may communicate signaling using an SRS hopping scheme based on a numerical quantity of orthogonal frequency division multiplexing (OFDM) symbols in each set of OFDM symbols in a sounding reference signal (SRS) resource. Additionally, or alternatively, the UEs and the network entities may communicate signaling using a power normalization factor that depends on the numerical quantity of OFDM symbols and a numerical quantity of antenna ports for the SRS. In some examples, a network entity may indicate the numerical quantity of antenna ports, the numerical quantity of OFDM symbols in each OFDM symbol set, or both to a UE in control signaling. The UE may transmit the SRS to the network entity using the SRS resource and in accordance with the SRS hopping scheme, the power normalization factor, or both.

### CROSS REFERENCE

The present application for patent claims the benefit of U.S. Provisional Patent Application No. 63/494,733 by HUANG et al., entitled “MULTIPLE ANTENNA PORT SOUNDING REFERENCE SIGNAL TRANSMISSION USING SETS OF SYMBOLS,” filed Apr. 6, 2023, assigned to the assignee hereof, and expressly incorporated by reference herein.

### FIELD OF TECHNOLOGY

The following relates to wireless communications, including multiple antenna port sounding reference signal (SRS) transmission using sets of symbols.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support multiple antenna port sounding reference signal (SRS) transmission using sets of symbols. For example, the described techniques provide for one or more user equipment (UEs) and network entities to communicate using an SRS hopping scheme based on a numerical quantity of orthogonal frequency division multiplexing (OFDM) symbols in each set of OFDM symbols in an SRS resource. Additionally, or alternatively, the described techniques provide for the UEs and the network entities to communicate using a power normalization factor that depends on the numerical quantity of OFDM symbols and a numerical quantity of antenna ports for the SRS. In some examples, a network entity may indicate the numerical quantity of antenna ports, the numerical quantity of OFDM symbols in each OFDM symbol set, or both to a UE in control signaling. The UE may transmit the SRS to the network entity using the SRS resource and in accordance with the SRS hopping scheme, the power normalization factor, or both.

A method for wireless communications at a UE is described. The method may include receiving first signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of a set of multiple antenna ports associated with the respective set of OFDM symbols, the numerical quantity being greater than one and transmitting an SRS using the SRS resource in accordance with an SRS hopping scheme associated with the numerical quantity of OFDM symbols.

An apparatus for wireless communications at a UE is described. The apparatus may include at least one processor and memory coupled with the processor, the memory storing instructions executable by the at least one processor (e.g., directly, indirectly, after pre-processing, without pre-processing) to cause the apparatus to receive first signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of a set of multiple antenna ports associated with the respective set of OFDM symbols, the numerical quantity being greater than one and transmit an SRS using the SRS resource in accordance with an SRS hopping scheme associated with the numerical quantity of OFDM symbols.

Another apparatus for wireless communications at a UE is described. The apparatus may include means for receiving first signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of a set of multiple antenna ports associated with the respective set of OFDM symbols, the numerical quantity being greater than one and means for transmitting an SRS using the SRS resource in accordance with an SRS hopping scheme associated with the numerical quantity of OFDM symbols.

A non-transitory computer-readable medium storing code for wireless communications at a UE is described. The code may include instructions executable by at least one processor (e.g., directly, indirectly, after pre-processing, without pre-processing) to receive first signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of a set of multiple antenna ports associated with the respective set of OFDM symbols, the numerical quantity being greater than one and transmit an SRS using the SRS resource in accordance with an SRS hopping scheme associated with the numerical quantity of OFDM symbols.

Some examples of the method, apparatuses, and non-transitory computer-readable medium described herein may further include operations, features, means, or instructions for applying a different SRS sequence to the each respective set of OFDM symbols in accordance with the SRS hopping scheme, where sequence hopping may be enabled at the UE.

Some examples of the method, apparatuses, and non-transitory computer-readable medium described herein may further include operations, features, means, or instructions for applying a different SRS sequence to each OFDM symbol of the set of multiple sets of OFDM symbols in accordance with the SRS hopping scheme, where sequence hopping may be enabled at the UE.

Some examples of the method, apparatuses, and non-transitory computer-readable medium described herein may further include operations, features, means, or instructions for applying a comb offset to the set of multiple antenna ports in accordance with the SRS hopping scheme, where comb offset hopping may be enabled at the UE.

Some examples of the method, apparatuses, and non-transitory computer-readable medium described herein may further include operations, features, means, or instructions for applying a comb offset to the portion of antenna ports in accordance with the SRS hopping scheme, where comb offset hopping may be enabled at the UE.

Some examples of the method, apparatuses, and non-transitory computer-readable medium described herein may further include operations, features, means, or instructions for applying a cyclic shift offset to the set of multiple antenna ports in accordance with the SRS hopping scheme, where cyclic shift hopping may be enabled at the UE.

Some examples of the method, apparatuses, and non-transitory computer-readable medium described herein may further include operations, features, means, or instructions for applying a cyclic shift offset to the portion of antenna ports in accordance with the SRS hopping scheme, where cyclic shift hopping may be enabled at the UE.

Some examples of the method, apparatuses, and non-transitory computer-readable medium described herein may further include operations, features, means, or instructions for receiving second signaling indicating a numerical quantity of antenna ports associated with an SRS, where the SRS may be transmitted in accordance with a power normalization factor that may be based on a relationship between the numerical quantity of antenna ports and the numerical quantity of OFDM symbols.

A method for wireless communications at a UE is described. The method may include receiving first signaling indicating a numerical quantity of antenna ports of a set of multiple antenna ports associated with an SRS, receiving second signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of the set of multiple antenna ports, the numerical quantity of OFDM symbols being greater than one, and transmitting the SRS using the SRS resource in accordance with a power normalization factor that is based on the numerical quantity of antenna ports and the numerical quantity of OFDM symbols.

An apparatus for wireless communications at a UE is described. The apparatus may include at least one processor and memory coupled with the processor, the memory storing instructions executable by the at least one processor (e.g., directly, indirectly, after pre-processing, without pre-processing) to cause the apparatus to receive first signaling indicating a numerical quantity of antenna ports of a set of multiple antenna ports associated with an SRS, receive second signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of the set of multiple antenna ports, the numerical quantity of OFDM symbols being greater than one, and transmit the SRS using the SRS resource in accordance with a power normalization factor that is based on the numerical quantity of antenna ports and the numerical quantity of OFDM symbols.

Another apparatus for wireless communications at a UE is described. The apparatus may include means for receiving first signaling indicating a numerical quantity of antenna ports of a set of multiple antenna ports associated with an SRS, means for receiving second signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of the set of multiple antenna ports, the numerical quantity of OFDM symbols being greater than one, and means for transmitting the SRS using the SRS resource in accordance with a power normalization factor that is based on the numerical quantity of antenna ports and the numerical quantity of OFDM symbols.

A non-transitory computer-readable medium storing code for wireless communications at a UE is described. The code may include instructions executable by at least one processor (e.g., directly, indirectly, after pre-processing, without pre-processing) to receive first signaling indicating a numerical quantity of antenna ports of a set of multiple antenna ports associated with an SRS, receive second signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of the set of multiple antenna ports, the numerical quantity of OFDM symbols being greater than one, and transmit the SRS using the SRS resource in accordance with a power normalization factor that is based on the numerical quantity of antenna ports and the numerical quantity of OFDM symbols.

In some examples of the method, apparatuses, and non-transitory computer-readable medium described herein, the power normalization factor may be based on an inverse square root relationship between the numerical quantity of antenna ports and the numerical quantity of OFDM symbols.

A method for wireless communications at a network entity is described. The method may include transmitting first signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of a set of multiple antenna ports associated with the respective set of OFDM symbols, the numerical quantity being greater than one and receiving an SRS using the SRS resource in accordance with an SRS hopping scheme associated with the numerical quantity of OFDM symbols.

An apparatus for wireless communications at a network entity is described. The apparatus may include at least one processor and memory coupled with the processor, the memory storing instructions executable by the at least one processor (e.g., directly, indirectly, after pre-processing, without pre-processing) to cause the apparatus to transmit first signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of a set of multiple antenna ports associated with the respective set of OFDM symbols, the numerical quantity being greater than one and receive an SRS using the SRS resource in accordance with an SRS hopping scheme associated with the numerical quantity of OFDM symbols.

Another apparatus for wireless communications at a network entity is described. The apparatus may include means for transmitting first signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of a set of multiple antenna ports associated with the respective set of OFDM symbols, the numerical quantity being greater than one and means for receiving an SRS using the SRS resource in accordance with an SRS hopping scheme associated with the numerical quantity of OFDM symbols.

A non-transitory computer-readable medium storing code for wireless communications at a network entity is described. The code may include instructions executable by at least one processor (e.g., directly, indirectly, after pre-processing, without pre-processing) to transmit first signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of a set of multiple antenna ports associated with the respective set of OFDM symbols, the numerical quantity being greater than one and receive an SRS using the SRS resource in accordance with an SRS hopping scheme associated with the numerical quantity of OFDM symbols.

In some examples of the method, apparatuses, and non-transitory computer-readable medium described herein, a different SRS sequence may be applied to each of the respective set of OFDM symbols in accordance with the SRS hopping scheme.

In some examples of the method, apparatuses, and non-transitory computer-readable medium described herein, a different SRS sequence may be applied to each OFDM symbol of the set of multiple sets of OFDM symbols in accordance with the SRS hopping scheme.

In some examples of the method, apparatuses, and non-transitory computer-readable medium described herein, a comb offset may be applied to the set of multiple antenna ports in accordance with the SRS hopping scheme.

In some examples of the method, apparatuses, and non-transitory computer-readable medium described herein, a comb offset may be applied to the portion of antenna ports in accordance with the SRS hopping scheme.

In some examples of the method, apparatuses, and non-transitory computer-readable medium described herein, a cyclic shift offset may be applied to the set of multiple antenna ports in accordance with the SRS hopping scheme.

In some examples of the method, apparatuses, and non-transitory computer-readable medium described herein, a cyclic shift offset may be applied to the portion of antenna ports in accordance with the SRS hopping scheme.

Some examples of the method, apparatuses, and non-transitory computer-readable medium described herein may further include operations, features, means, or instructions for transmitting second signaling indicating a numerical quantity of antenna ports associated with an SRS, where the SRS may be received in accordance with a power normalization factor that may be based on a relationship between the numerical quantity of antenna ports and the numerical quantity of OFDM symbols.

A method for wireless communications at a network entity is described. The method may include transmitting first signaling indicating a numerical quantity of antenna ports of a set of multiple antenna ports associated with an SRS, transmitting second signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of the set of multiple antenna ports, the numerical quantity of OFDM symbols being greater than one, and receiving the SRS using the SRS resource in accordance with a power normalization factor that is based on the numerical quantity of antenna ports and the numerical quantity of OFDM symbols.

An apparatus for wireless communications at a network entity is described. The apparatus may include at least one processor and memory coupled with the processor, the memory storing instructions executable by the at least one processor (e.g., directly, indirectly, after pre-processing, without pre-processing) to cause the apparatus to transmit first signaling indicating a numerical quantity of antenna ports of a set of multiple antenna ports associated with an SRS, transmit second signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of the set of multiple antenna ports, the numerical quantity of OFDM symbols being greater than one, and receive the SRS using the SRS resource in accordance with a power normalization factor that is based on the numerical quantity of antenna ports and the numerical quantity of OFDM symbols.

Another apparatus for wireless communications at a network entity is described. The apparatus may include means for transmitting first signaling indicating a numerical quantity of antenna ports of a set of multiple antenna ports associated with an SRS, means for transmitting second signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of the set of multiple antenna ports, the numerical quantity of OFDM symbols being greater than one, and means for receiving the SRS using the SRS resource in accordance with a power normalization factor that is based on the numerical quantity of antenna ports and the numerical quantity of OFDM symbols.

A non-transitory computer-readable medium storing code for wireless communications at a network entity is described. The code may include instructions executable by at least one processor (e.g., directly, indirectly, after pre-processing, without pre-processing) to transmit first signaling indicating a numerical quantity of antenna ports of a set of multiple antenna ports associated with an SRS, transmit second signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of the set of multiple antenna ports, the numerical quantity of OFDM symbols being greater than one, and receive the SRS using the SRS resource in accordance with a power normalization factor that is based on the numerical quantity of antenna ports and the numerical quantity of OFDM symbols.

In some examples of the method, apparatuses, and non-transitory computer-readable medium described herein, the power normalization factor may be based on an inverse square root relationship between the numerical quantity of antenna ports and the numerical quantity of OFDM symbols.

### BRIEF DESCRIPTION OF THE DRAWINGS

FIGS. 1 and 2 show examples of a wireless communications system that support multiple antenna port sounding reference signal (SRS) transmission using sets of symbols in accordance with one or more aspects of the present disclosure.

FIGS. 3A, 3B, 4A, 4B, 5A, and 5B show examples of resource diagrams that support multiple antenna port SRS transmission using sets of symbols in accordance with one or more aspects of the present disclosure.

FIGS. 6 and 7 show example process flows that support multiple antenna port SRS transmission using sets of symbols in accordance with one or more aspects of the present disclosure.

FIGS. 8 and 9 show block diagrams of devices that support multiple antenna port SRS transmission using sets of symbols in accordance with one or more aspects of the present disclosure.

FIG. 10 shows a block diagram of a communications manager that supports multiple antenna port SRS transmission using sets of symbols in accordance with one or more aspects of the present disclosure.

FIG. 11 shows a diagram of a system including a device that supports multiple antenna port SRS transmission using sets of symbols in accordance with one or more aspects of the present disclosure.

FIGS. 12 and 13 show block diagrams of devices that support multiple antenna port SRS transmission using sets of symbols in accordance with one or more aspects of the present disclosure.

FIG. 14 shows a block diagram of a communications manager that supports multiple antenna port SRS transmission using sets of symbols in accordance with one or more aspects of the present disclosure.

FIG. 15 shows a diagram of a system including a device that supports multiple antenna port SRS transmission using sets of symbols in accordance with one or more aspects of the present disclosure.

FIGS. 16 through 19 show flowcharts illustrating methods that support multiple antenna port SRS transmission using sets of symbols in accordance with one or more aspects of the present disclosure.

### DETAILED DESCRIPTION

In some wireless communications systems, one or more wireless devices (e.g., user equipment (UEs), network entities, or both) may communicate using multiple antenna ports, where each antenna port may represent a unique communication channel. For example, each antenna port may have a dedicated reference signal and a resource grid including a quantity of resource blocks (RBs), a subcarrier spacing (SCS) configuration, and a transmission direction. In some cases, the wireless devices may use a codebook to map data to each antenna port. The codebook may be a matrix that transforms a data bit to another set of data that maps to each antenna port. For codebook-based uplink transmissions, a wireless communications device may simultaneously transmit reference signals for multiple antenna ports in a single orthogonal frequency division multiplexing (OFDM) symbol, or duration in time, which may result in reduced transmit power and throughput for each antenna port due to splitting the power for the multiple antenna ports.

For example, a UE may generate a sounding reference signal (SRS) using a base sequence, which may be referred to as an SRS sequence, and may transmit the generated SRS to a network entity in an SRS resource, which may span a quantity of OFDM symbols and may use the multiple antenna ports. In some cases, sequence hopping may be disabled for the SRS transmissions, such that the UE may apply a same SRS sequence to SRS transmissions on each OFDM symbol in the SRS resource. In some other cases, sequence hopping may be enabled for the SRS transmission, such that the UE may apply a different SRS sequence to the SRS transmission on each OFDM symbol in the SRS resource.

In some examples, to increase transmit power for each antenna port, which may in turn increase throughput and signaling efficiency (e.g., due to reduced communication errors and retransmissions), the wireless communication device may transmit reference signals of each antenna port in multiple OFDM symbols. However, the wireless communication device may lack a mechanism for performing SRS sequence generation, performing SRS sequence hopping, and/or mapping the generated sequence to resource elements in the physical layer if the reference signals dedicated to multiple antenna ports are transmitted simultaneously in a single OFDM symbol.

As described herein, a UE may receive an indication of a numerical quantity of OFDM symbols in sets of OFDM symbols in a reference signal resource (e.g., an SRS resource). Each OFDM symbol in each set of OFDM symbols may be assigned multiple antenna ports dedicated to the reference signal (e.g., an SRS). For example, if the numerical quantity of OFDM symbols in a set is 2, and there are 8 antenna ports, then there may be 4 antenna ports assigned to each OFDM symbol in the set. The numerical quantity of OFDM symbols may be greater than one. In some cases, the UE may transmit the reference signal using the reference signal resource and a reference signal hopping scheme (e.g., an SRS hopping scheme). The SRS hopping scheme may specify that the UE is to apply different SRS sequences on a per OFDM symbol set basis or on a per OFDM symbol basis. Similarly, the SRS hopping scheme may specify for the UE to apply different comb offsets or cyclic shift offsets to antenna ports for the OFDM symbol set or for each OFDM symbol. In some examples, the UE may receive an indication of a numerical quantity of antenna ports assigned to the reference signal. The UE may transmit the SRS in accordance with a power normalization factor that the UE calculates based on a relationship between the numerical quantity of antenna ports and the numerical quantity of OFDM symbols in each OFDM symbol set.

Aspects of the disclosure are initially described in the context of wireless communications systems. Aspects of the disclosure are additionally described in the context of resource diagrams and process flows. Aspects of the disclosure are further illustrated by and described with reference to apparatus diagrams, system diagrams, and flowcharts that relate to multiple antenna port SRS transmission using sets of OFDM symbols.

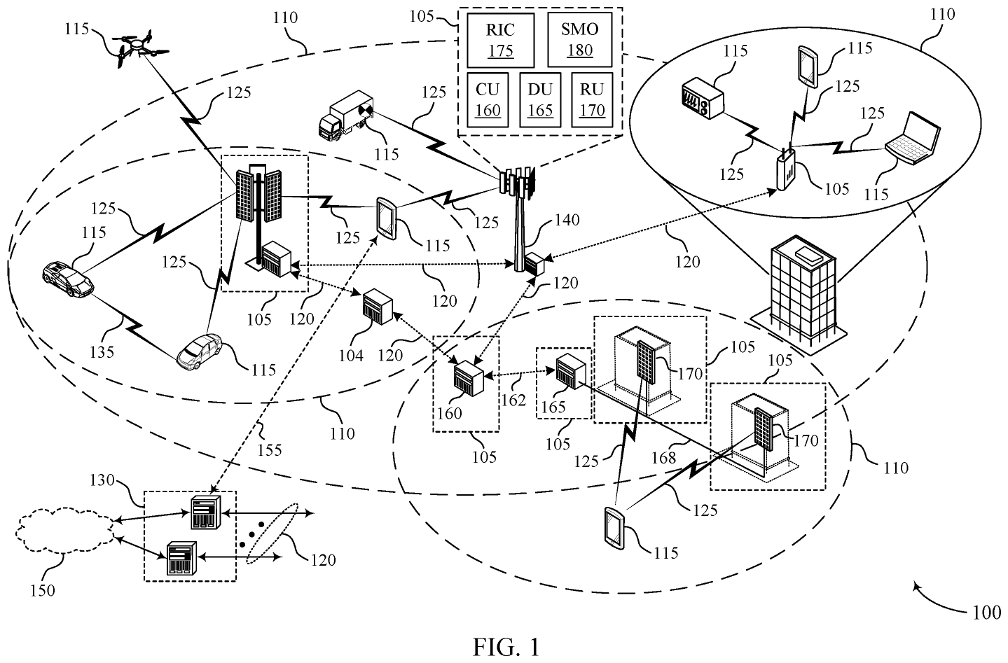

FIG. 1 shows an example of a wireless communications system 100 that supports multiple antenna port SRS transmission using sets of symbols in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support multiple antenna port SRS transmission using sets of symbols as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as OFDM or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (cMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may receive an indication of a numerical quantity of OFDM symbols in sets of OFDM symbols in a reference signal resource (e.g., an SRS resource). Each OFDM symbol in each set of OFDM symbols may be assigned multiple antenna ports dedicated to the reference signal (e.g., an SRS). For example, if the numerical quantity of OFDM symbols in a set is 2, and there are 8 antenna ports, then there may be 4 antenna ports assigned to each OFDM symbol in the set. The numerical quantity of OFDM symbols may be greater than one. In some cases, the UE 115 may transmit the reference signal using the reference signal resource and a reference signal hopping scheme (e.g., an SRS hopping scheme). The SRS hopping scheme may specify that the UE is to apply different SRS sequences on a per OFDM symbol set basis or on a per OFDM symbol basis. Similarly, the SRS hopping scheme may specify that the UE is to apply different comb offsets or cyclic shift offsets to antenna ports for the OFDM symbol set or for each OFDM symbol. In some examples, the UE 115 may receive an indication of a numerical quantity of antenna ports assigned to the reference signal. The UE may transmit the SRS in accordance with a power normalization factor that the UE 115 calculates based on a relationship between the numerical quantity of antenna ports and the numerical quantity of OFDM symbols in each OFDM symbol set.

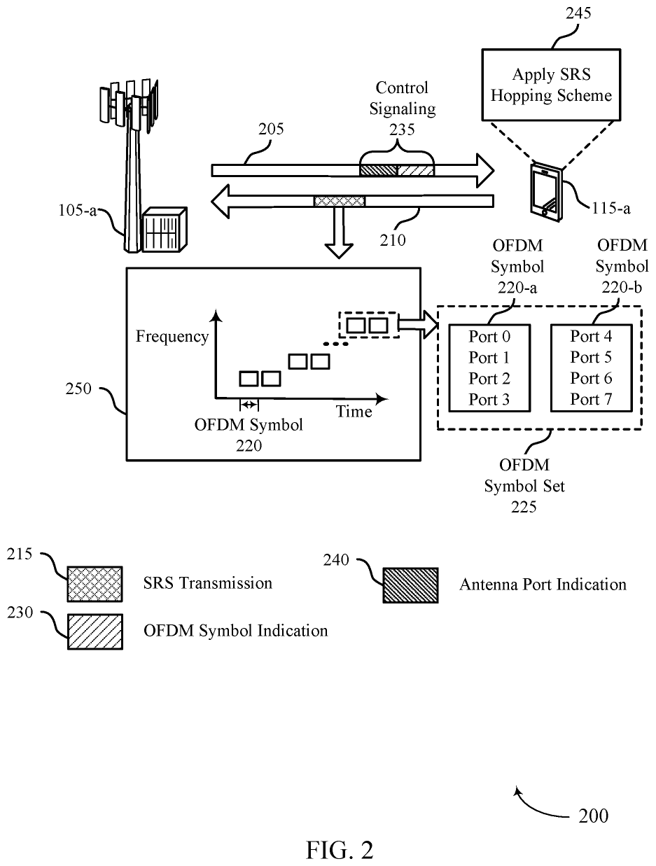

FIG. 2 shows an example of a wireless communications system 200 that supports multiple antenna port SRS transmission using sets of symbols in accordance with one or more aspects of the present disclosure. In some examples, the wireless communications system 200 may implement, or be implemented by, aspects of the wireless communications system 100. The wireless communications system 200 may include a network entity 105-a and a UE 115-a, which may represent examples of the network entities 105 and the UEs 115 described with reference to FIG. 1.

In some examples, the network entity 105-a may transmit control information, data, or both to the UE 115-a using a downlink communication link 205. Similarly, the UE 115-a may transmit control information, data, or both to the network entity 105-a using an uplink communication link 210. For example, the UE 115-a may perform one or more reference signal transmissions using a reference signal hopping scheme and/or a power normalization factor that depends on a numerical quantity of OFDM symbols, a numerical quantity of antenna ports, or both.

In the wireless communications system 200, one or more wireless devices (e.g., the UE 115-a and the network entity 105-a) may communicate using multiple antenna ports, where each antenna port may represent a unique communication channel. For example, each antenna port may have a dedicated reference signal and a resource grid including a quantity of RBs, an SCS configuration, and a transmission direction. In some cases, the wireless devices may use a codebook to map data to each antenna port. The codebook may be or include a matrix that transforms a data bit to another set of data that maps to each antenna port. For codebook-based uplink transmissions, a wireless communications device may simultaneously transmit reference signals dedicated to multiple antenna ports in a single symbol, or duration in time, which may result in reduced transmit power and throughput for each antenna port due to splitting the power for the multiple antenna ports.

For example, a UE 115-a may generate an SRS transmission 215 using a base sequence, which may be referred to as an SRS sequence, and may transmit the generated SRS to a network entity 105-a in an SRS resource, which may span a quantity of OFDM symbols 220 and may use the multiple antenna ports. In some cases, sequence hopping may be disabled for the SRS transmission 215, such that the UE 115-a may apply a same SRS sequence to SRS transmissions on each OFDM symbol 220 in the SRS resource. In some other cases, sequence hopping may be enabled for the SRS transmission, such that the UE 115-a may apply a different SRS sequence to the SRS transmission on each OFDM symbol 220 in the SRS resource. The UE 115-a may use one or more equations to update the SRS sequences, which may be pseudo-random equations. In some cases, for group hopping, the UE 115-a may use Equation 1:

$${f}_{gh} ( {n}_{s , f}^{μ} , {l}^{′} ) = ( {\sum }_{m = 0}^{7} c ( 8 ( {n}_{s , f}^{μ} {N}_{symb}^{slot} + {l}_{0} + {l}^{′} ) + m ) \cdot {2}^{m} ) mod 30 , \qquad ( 1 )$$

$$v = 0$$

where l′ is an OFDM symbol index, l₀ is an offset of a starting OFDM symbol index,
n_{s,f}^{μ} is a slot index, N_{symb}^{slot} is a numerical quantity of symbols in each slot, m is a resource block size, and v is a base sequence number within a group. In some cases, c(n) may be an output of a pseudo-random sequence with length, M_{PN}, where n=0,1, . . . , M_{PN}−1, c(n) may be defined by Equation 2:

$$c ( n ) = ( {x}_{1} ( n + {N}_{C} ) + {x}_{2} ( n + {N}_{C} ) ) mod 2 \qquad ( 2 )$$

$${x}_{1} ( n + 31 ) = ( {x}_{1} ( n + 3 ) + {x}_{1} ( n ) ) mod 2$$

$${x}_{2} ( n + 31 ) = ( {x}_{2} ( n + 3 ) + {x}_{2} ( n + 2 ) + {x}_{2} ( n + 1 ) + {x}_{2} ( n ) ) mod 2$$

where N_{C}=1600 and the first m-sequence x₁(n) may be initialized with x₁(0)=1,x₁(n)=0,n=1, 2, . . . , 30. The initialization of the second m-sequence, x₂(n), may be denoted by cᵢₙᵢₜ=Σᵢ₌₀³⁰x₂(i)·2ⁱ with the value depending on the application of the sequence.

In some other cases, for sequence hopping, the UE 115-a may use Equation 3:

$${f}_{gh} ( {n}_{s , f}^{μ} , {l}^{′} ) = 0 \qquad ( 3 )$$

$$v = \{ \begin{matrix}c ( {n}_{s , f}^{μ} {N}_{symb}^{slot} + {l}_{0} + {l}^{′} ) & {M}_{sc , b}^{SRS} \geq 6 {N}_{sc}^{RB} \\ 0 & otherwise\end{matrix}$$

where M_{sc,b}^{SRS} is a length of the SRS sequence and N_{sc}^{RB} is a numerical quantity of resource blocks per subcarrier.

After the UE 115-a determines the SRS sequence for each OFDM symbol 220, the UE 115-a may apply a same sequence to each antenna port in an SRS resource. The UE 115-a may map entries of an SRS sequence to a set of resource elements with a power normalization factor of

$$\sqrt{\frac{1}{{N}_{ap}}} ,$$

where Nₐₚ is a numerical quantity of configured antenna ports.

In some examples, to increase transmit power for each antenna port, which may in turn increase throughput and signaling efficiency (e.g., due to reduced communication errors and retransmissions), the wireless communication device may transmit reference signals of each antenna port in multiple OFDM symbols 220. The UE 115-a may send the SRS transmission 215 to the network entity 105-a using multiple OFDM symbols 220, which may be divided into OFDM symbol sets 225 with a numerical quantity, L, of OFDM symbols 220. For example, the UE 115-a may support 8 antenna ports for an SRS transmission 215 that is a codebook-based physical uplink shared channel (PUSCH), which may provide for the UE 115-a to transmit, or sound, the SRS transmission 215 in multiple OFDM symbols 220. Thus, the UE 115-a may use a relatively high power to sound each antenna port. If each OFDM symbol set 225 has a numerical quantity of OFDM symbols 220, L, the transmit power for each OFDM symbol 220 may be a total transmit power divided by L (e.g., power/2 or power/4 per antenna port for 8 antenna ports in 4 or 2 OFDM symbols, respectively, when compared with power/8 if each port is assigned to an OFDM symbol 220).

For example, as illustrated in the wireless communications system 200, L may be 2 OFDM symbols 220, where the UE 115-a may use the OFDM symbol 220-a and the OFDM symbol 220-b for a transmission assigned to 8 antenna ports, such that the UE 115-a uses OFDM symbol 220-a to transmit the SRS transmission 215 using Port 0 through Port 3 and the OFDM symbol 220-b to transmit the SRS transmission 215 using Port 4 through Port 7. In some other examples, L, may be 4 OFDM symbols 220, such that with 8 antenna ports, the UE 115-a may send the SRS transmission 215 using two antenna ports per OFDM symbol 220. Although the wireless communications system 200 illustrates sets of 2 OFDM symbols 220, L may be any quantity of OFDM symbols 220.

However, the wireless communication device, such as the UE 115-a, may lack a mechanism for performing SRS sequence generation, performing SRS sequence hopping, and/or mapping the generated sequence to resource elements in the physical layer if reference signals dedicated to multiple antenna ports are transmitted simultaneously in a single OFDM symbol 220. Further, the calculation for obtaining a power normalization factor may be updated when reference signals dedicated to multiple antenna ports are transmitted simultaneously in a single OFDM symbol 220.

In some examples, a UE 115-a may receive an OFDM symbol indication 230 that includes a numerical quantity of OFDM symbols 220 in each OFDM symbol set 225, which may be referred to as L. Each OFDM symbol set 225 may span a reference signal resource (e.g., an SRS resource). Each OFDM symbol 220 in the OFDM symbol set 225 may be assigned multiple antenna ports dedicated to the reference signal (e.g., an SRS). For example, if L is 2, and there are 8 antenna ports, then there may be 4 antenna ports assigned to each OFDM symbol 220. That is, Port 0, Port 1, Port 2, and Port 3 may be assigned to the OFDM symbol 220-a, while Port 4, Port 5, Port 6, and Port 7 may be assigned to the OFDM symbol 220-b in the OFDM symbol set 225. In some cases, L may be greater than one.

The UE 115-a may receive the OFDM symbol indication in control signaling 235, which may be an example of a downlink control information (DCI) message, RRC signaling, a medium access control-control element (MAC-CE), or any other type of control signaling. Additionally, or alternatively, the UE 115-a may receive an antenna port indication 240 in the control signaling 235 (e.g., in a same control signal or in a different control signal). The antenna port indication 240 may include a numerical quantity of antenna ports assigned to an SRS resource, Nₐₚ, such as 8 in the example illustrated in the wireless communications system 200. Although the numerical quantity of antenna ports is illustrated as 8 in the wireless communications system 200, the numerical quantity of antenna ports may be any value.

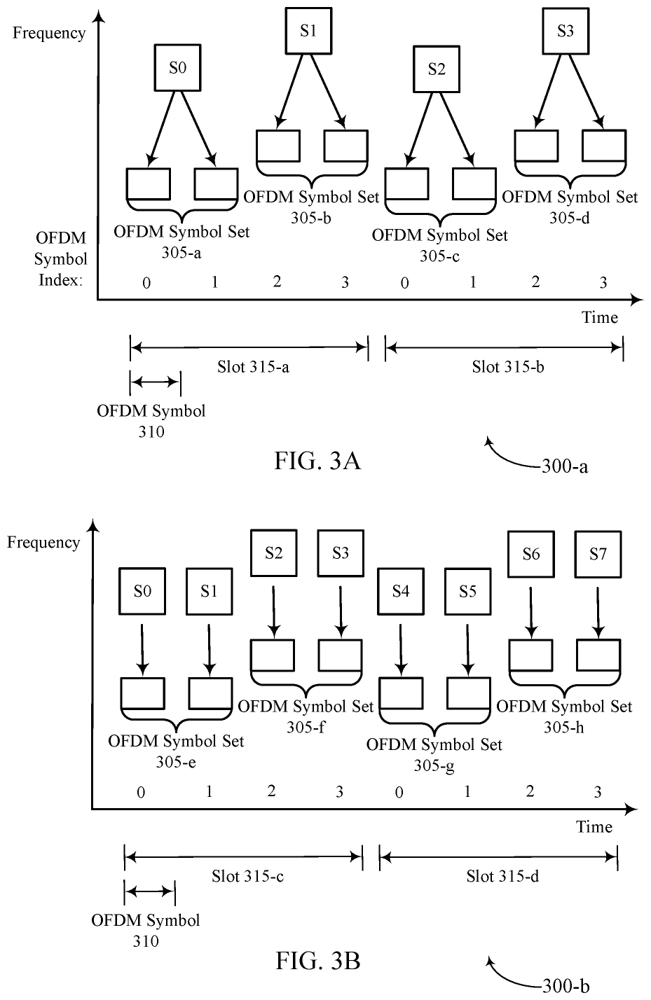

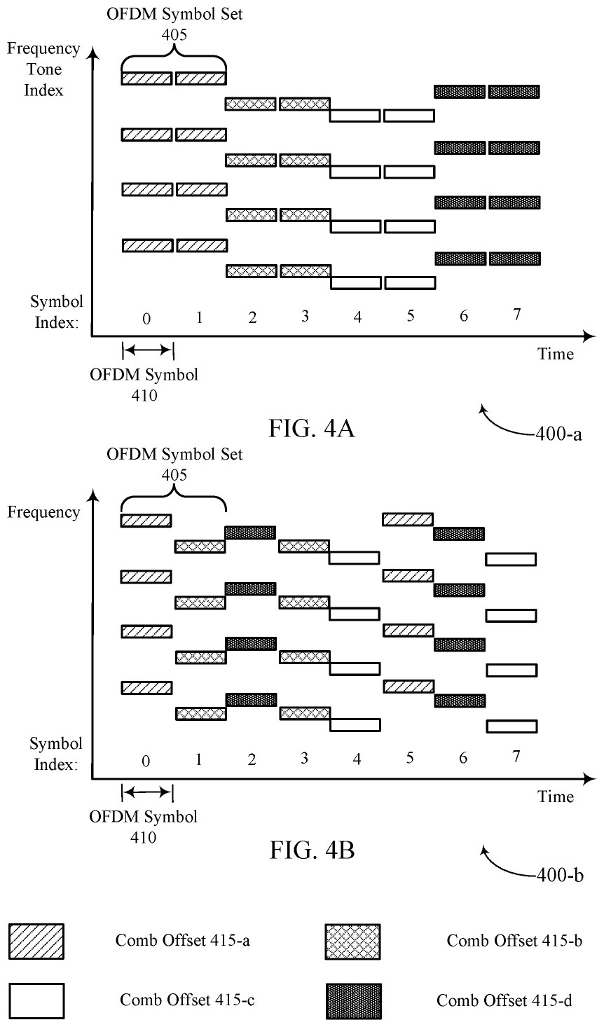

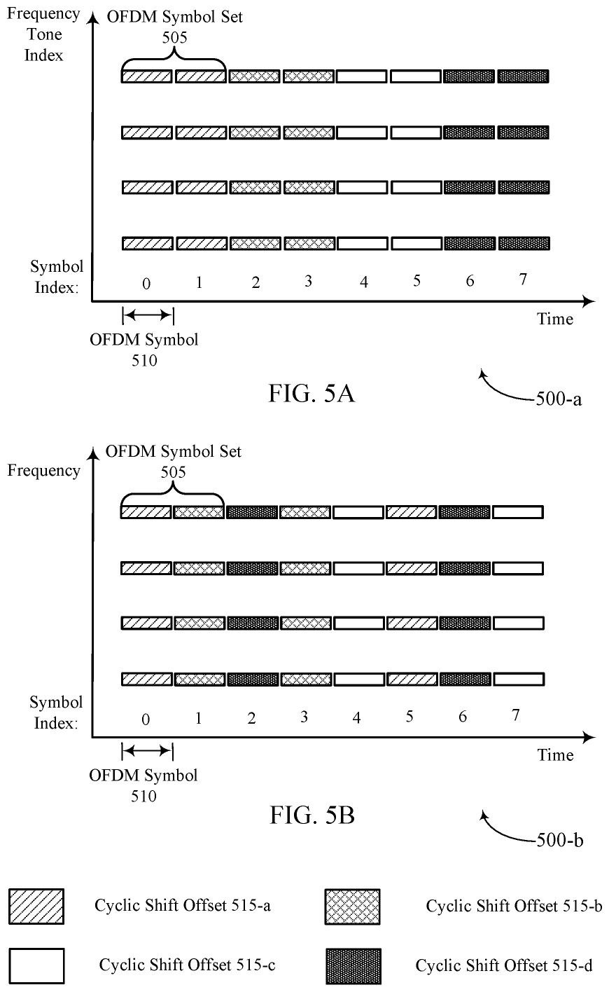

In some cases, at 245, the UE 115-a may apply an SRS hopping scheme to the SRS transmission 215. For example, the SRS hopping scheme may specify for the UE 115-a to apply different SRS sequences on a per OFDM symbol set 225 basis or on a per OFDM symbol 220 basis, which is described in further detail with respect to FIGS. 3A and 3B. Similarly, the SRS hopping scheme may specify for the UE 115-a to apply different comb offsets or cyclic shift offsets to antenna ports for the OFDM symbol set 225 or for each OFDM symbol 220, which is described in further detail with respect to FIGS. 4A, 4B, 5A, and 5B.

The UE 115-a may perform the SRS transmission 215 to the network entity 105-a in accordance with the SRS hopping scheme and using one or more SRS resources in the resource diagram 250. For example, the UE 115-a may transmit one or more SRSs to the network entity 105-a using one or more OFDM symbol sets 225, which may include the numerical quantity of OFDM symbols 220. Additionally, or alternatively, the UE 115-a may transmit the SRS in accordance with a power normalization factor that the UE 115-a calculates based on a relationship between the numerical quantity of antenna ports and the numerical quantity of symbols in each symbol set.

In some examples, as a total quantity of antenna ports may be mapped to L OFDM symbols 220 in the OFDM symbol set 225, the power normalization factor per OFDM symbol 220 may be

$$\sqrt{\frac{1}{( {N}_{ap} / L )}} = \sqrt{\frac{L}{{N}_{ap}}} .$$

Thus, the UE 115-a may map each antenna port of the SRS resource in sequence starting with r^{(p}^{ᵢ}⁾(0,l′) to resource elements (k,l) in a slot for each of the antenna ports pᵢ according to the power normalization factor for the SRS transmission 215 according to Equation 4:

$$( 4 )$$

$${a}_{{K}_{TC} {k}^{′} + {k}_{0}^{( {p}_{i} )} , {l}^{′} + {l}_{0}}^{( {p}_{i} )} = \{ \begin{matrix}\frac{1}{\sqrt{{N}_{ap}}} {β}_{SRS} {r}^{( {p}_{i} )} ( {k}^{′} , {l}^{′} ) & {k}^{′} = 0 , 1 , … , {M}_{sc , b}^{SRS} - 1 & {l}^{′} = 0 , 1 , … , {N}_{symb}^{SRS} - 1 \\ 0 & otherwise & \end{matrix}$$

where k₀^{(p}^{ᵢ}⁾ is a frequency-domain starting position, K_{TC} is a signal transmission comb, and k′ is a frequency shift.

FIGS. 3A and 3B show examples of a resource diagram 300-a and a resource diagram 300-b that support multiple antenna port SRS transmission using sets of symbols in accordance with one or more aspects of the present disclosure. In some examples, the resource diagram 300-a and the resource diagram 300-b may implement, or be implemented by, aspects of the wireless communications system 100 and the wireless communications system 200. The resource diagram 300-a and the resource diagram 300-b may illustrate an example of a UE (e.g., a UE 115 as described with reference to FIGS. 1 and 2) applying different SRS sequences for an SRS transmission on a per OFDM symbol set 305 basis or on a per OFDM symbol 310 basis, respectively.

In some examples, to increase transmit power for each antenna port, which may in turn increase throughput and signaling efficiency, a wireless communication device, such as a UE or a network entity, may transmit reference signals of each antenna port in multiple OFDM symbols 310. The multiple OFDM symbols 310 may be divided into OFDM symbol sets 305 with a numerical quantity, L, of OFDM symbols 310. For example, 8 antenna ports may map to 2 OFDM symbols 310, where L is 2, such that the OFDM symbol set 305-a through the OFDM symbol set 305-h each have 2 OFDM symbols 310. Although the resource diagram 300-a and the resource diagram 300-b illustrate sets of 2 OFDM symbols 310, L may be any quantity of OFDM symbols 310.

Each OFDM symbol set 305 may span a reference signal resource (e.g., an SRS resource), and a slot 315 may include multiple OFDM symbols 310, OFDM symbol sets 305, or both. For example, the resource diagram 300-a illustrates a slot 315-a that includes an OFDM symbol set 305-a and an OFDM symbol set 305-b that span 4 OFDM symbols, and a slot 315-b that includes an OFDM symbol set 305-c and an OFDM symbol set 305-d that spans 4 OFDM symbols. Similarly, the resource diagram 300-b illustrates a slot 315-c that includes an OFDM symbol set 305-e and an OFDM symbol set 305-f that span 4 OFDM symbols, and a slot 315-d that includes an OFDM symbol set 305-g and an OFDM symbol set 305-h that spans 4 OFDM symbols. Each slot may have an OFDM symbol index for each OFDM symbol 310, such as 0, 1, 2, and 3. Each OFDM symbol 310 in the OFDM symbol set 305 may be assigned multiple antenna ports dedicated to the reference signal (e.g., an SRS). For example, if L is 2, and there are 8 antenna ports, then there may be 4 antenna ports assigned to each OFDM symbol 310.

In some examples, the resource diagram 300-a may illustrate an example of a UE applying sequence hopping on a per OFDM symbol set 305 basis. The UE may apply a same SRS sequence to each OFDM symbol 310 in an OFDM symbol set 305, such that the antenna ports in an SRS resource are assigned a same SRS sequence. For example, in the resource diagram 300-a, the UE may apply an SRS sequence S0 to the OFDM symbol set 305-a, an SRS sequence S1 to the OFDM symbol set 305-b, an SRS sequence S2 to the OFDM symbol set 305-c, and an SRS sequence S3 to the OFDM symbol set 305-d. Thus, for group hopping in Equation 2 and sequence hopping in Equation 4, l′ may be replaced by

$$⌊ \frac{{l}^{′}}{2} ⌋ .$$

In some other examples, the resource diagram 300-b may illustrate an example of a UE applying sequence hopping on a per OFDM symbol 310 basis. The UE may apply a different SRS sequence to each OFDM symbol 310 in the OFDM symbol sets 305, such that different antenna ports in an SRS resource may use different SRS sequences. For example, in the resource diagram 300-b, the UE may apply an SRS sequence S0 and an SRS sequence S1 to the OFDM symbols 310 with indices 0 and 1, respectively, in the OFDM symbol set 305-e, an SRS sequence S2 and an SRS sequence S3 to the OFDM symbols 310 with indices 2 and 3, respectively, in the OFDM symbol set 305-f, an SRS sequence S4 and an SRS sequence S5 to the OFDM symbols 310 with indices 0 and 1, respectively, in the OFDM symbol set 305-g, and an SRS sequence S6 and an SRS sequence S7 to the OFDM symbols 310 with indices 2 and 3, respectively, in the OFDM symbol set 305-h.

FIGS. 4A and 4B show examples of a resource diagram 400-a and a resource diagram 400-b that support multiple antenna port SRS transmission using sets of symbols in accordance with one or more aspects of the present disclosure. In some examples, the resource diagram 400-a and the resource diagram 400-b may implement, or be implemented by, aspects of the wireless communications system 100 and the wireless communications system 200. The resource diagram 400-a and the resource diagram 400-b may illustrate an example of a UE (e.g., a UE 115 as described with reference to FIGS. 1 and 2) applying different comb offsets 415 to antenna ports for an OFDM symbol set 405 or for an OFDM symbol 410, respectively.

In some examples, to increase transmit power for each antenna port, which may in turn increase throughput and signaling efficiency, a wireless communication device, such as a UE or a network entity, may transmit reference signals of each antenna port in multiple OFDM symbols 410. The multiple OFDM symbols 410 may be divided into OFDM symbol sets 405 with a numerical quantity, L, of OFDM symbols 410. For example, 8 antenna ports may map to 2 OFDM symbols 410, where Lis 2, such that the OFDM symbol sets 405 each have 2 OFDM symbols 410. Although the resource diagram 400-a and the resource diagram 400-b illustrate sets of 2 OFDM symbols 410, L may be any quantity of OFDM symbols 410. Each OFDM symbol set 405 may span a reference signal resource (e.g., an SRS resource). Each OFDM symbol 410 in the OFDM symbol set 405 may be assigned multiple antenna ports dedicated to the reference signal (e.g., an SRS). For example, if Z is 2, and there are 8 antenna ports, then there may be 4 antenna ports assigned to each OFDM symbol 410.

In some examples, a UE may perform comb hopping in which a UE may apply a different comb offset 415 to different SRS transmissions in time. A comb offset 415 is a frequency value for equally spaced signals allocated over a transmission bandwidth. In some cases, if the comb offset 415 is zero for each of the SRS transmissions, the UE may not perform comb hopping (e.g., comb hopping may not be configured). If comb hopping is configured and SRS ports are TDMed over L OFDM symbols 410, the UE may apply different comb offsets 415 to antenna ports for an OFDM symbol set 405 or for an OFDM symbol 410.

In some examples, the resource diagram 400-a may illustrate an example of a UE applying different comb offsets 415 to antenna ports for an OFDM symbol set 405. The UE may determine a pseudo-random comb offset for each L OFDM symbols 410, or per OFDM symbol set 405. The UE may apply the comb offset 415 to the antenna ports over the L OFDM symbols 410. Thus, the antenna ports over the L OFDM symbols 410 may have a same comb offset 415 hopping pattern, but may not have a same comb (e.g., even within an OFDM symbol 410, different ports may use a different comb). For example, in the resource diagram 400-a, the UE may apply a comb offset 415-a to the OFDM symbols 410 with indices 0 and 1, a comb offset 415-b to the OFDM symbols 410 with indices 2 and 3, a comb offset 415-c to the OFDM symbols 410 with indices 4 and 5, and a comb offset 415-d to the OFDM symbols 410 with indices 6 and 7.

In some other examples, the resource diagram 400-b may illustrate an example of a UE applying different comb offsets 415 to antenna ports that are sounded on each OFDM symbol 410. The UE may determine a pseudo-random comb offset for each OFDM symbol 410. The UE may apply the comb offset 415 to the antenna ports assigned to the OFDM symbols 410. For example, in the resource diagram 400-b, the UE may apply a comb offset 415-a to the OFDM symbols 410 with indices 0 and 5, a comb offset 415-b to the OFDM symbols 410 with indices 1 and 3, a comb offset 415-c to the OFDM symbols 410 with indices 4 and 7, and a comb offset 415-d to the OFDM symbols 410 with indices 2 and 6.

FIGS. 5A and 5B show examples of a resource diagram 500-a and a resource diagram 500-b that support multiple antenna port SRS transmission using sets of symbols in accordance with one or more aspects of the present disclosure. In some examples, the resource diagram 500-a and the resource diagram 500-b may implement, or be implemented by, aspects of the wireless communications system 100 and the wireless communications system 200. The resource diagram 500-a and the resource diagram 500-b may illustrate an example of a UE (e.g., a UE 115 as described with reference to FIGS. 1 and 2) applying different cyclic shift offsets to antenna ports for an OFDM symbol set or for an OFDM symbol, respectively.

In some examples, to increase transmit power for each antenna port, which may in turn increase throughput and signaling efficiency, a wireless communication device, such as a UE or a network entity, may transmit reference signals of each antenna port in multiple OFDM symbols 510. The multiple OFDM symbols 510 may be divided into OFDM symbol sets 505 with a numerical quantity, L, of OFDM symbols 510. For example, 8 antenna ports may map to 2 OFDM symbols 510, where Lis 2, such that the OFDM symbol sets 505 each have 2 OFDM symbols 510. Although the resource diagram 500-a and the resource diagram 500-b illustrate sets of 2 OFDM symbols 510, L may be any quantity of OFDM symbols 510. Each OFDM symbol set 505 may span a reference signal resource (e.g., an SRS resource). Each OFDM symbol 510 in the OFDM symbol set 505 may be assigned multiple antenna ports dedicated to the reference signal (e.g., an SRS). For example, if L is 2, and there are 8 antenna ports, then there may be 4 antenna ports assigned to each OFDM symbol 510.

In some examples, a UE may perform cyclic shift hopping in which a UE may apply a different cyclic shift offset 515 to different SRS transmissions in time. A cyclic shift offset 515 is a duration which the UE may delay space-time streams with a different time reference. In some cases, if the cyclic shift offset 515 is zero for each of the SRS transmissions, the UE may not perform cyclic shift hopping (e.g., cyclic shift hopping may not be configured). If cyclic shift hopping is configured and SRS ports are TDMed over L OFDM symbols 510, the UE may apply different cyclic shift offsets 515 to antenna ports for an OFDM symbol set 505 or for an OFDM symbol 510.

In some examples, the resource diagram 500-a may illustrate an example of a UE applying different cyclic shift offsets 515 to antenna ports for an OFDM symbol set 505. The UE may determine a pseudo-random cyclic shift offset for each L OFDM symbols 510, or per OFDM symbol set 505. The UE may apply the cyclic shift offset 515 to the antenna ports over the L OFDM symbols 510. Thus, the antenna ports over the L OFDM symbols 510 may have a same cyclic shift offset 515 hopping pattern, but may not have a same cyclic shift (e.g., even within an OFDM symbol 510, different antenna ports may use a different cyclic shift). For example, in the resource diagram 500-a, the UE may apply a cyclic shift offset 515-a to the OFDM symbols 510 with indices 0 and 1, a cyclic shift offset 515-b to the OFDM symbols 510 with indices 2 and 3, a cyclic shift offset 515-c to the OFDM symbols 510 with indices 4 and 5, and a cyclic shift offset 515-d to the OFDM symbols 510 with indices 6 and 7.

In some other examples, the resource diagram 500-b may illustrate an example of a UE applying different cyclic shift offsets 515 to antenna ports that are sounded on each OFDM symbol 510. The UE may determine a pseudo-random cyclic shift offset for each OFDM symbol 510. The UE may apply the cyclic shift offset 515 to the antenna ports assigned to the OFDM symbols 510. For example, in the resource diagram 500-b, the UE may apply a cyclic shift offset 515-a to the OFDM symbols 510 with indices 0 and 5, a cyclic shift offset 515-b to the OFDM symbols 510 with indices 1 and 3, a cyclic shift offset 515-c to the OFDM symbols 510 with indices 4 and 7, and a cyclic shift offset 515-d to the OFDM symbols 510 with indices 2 and 6.

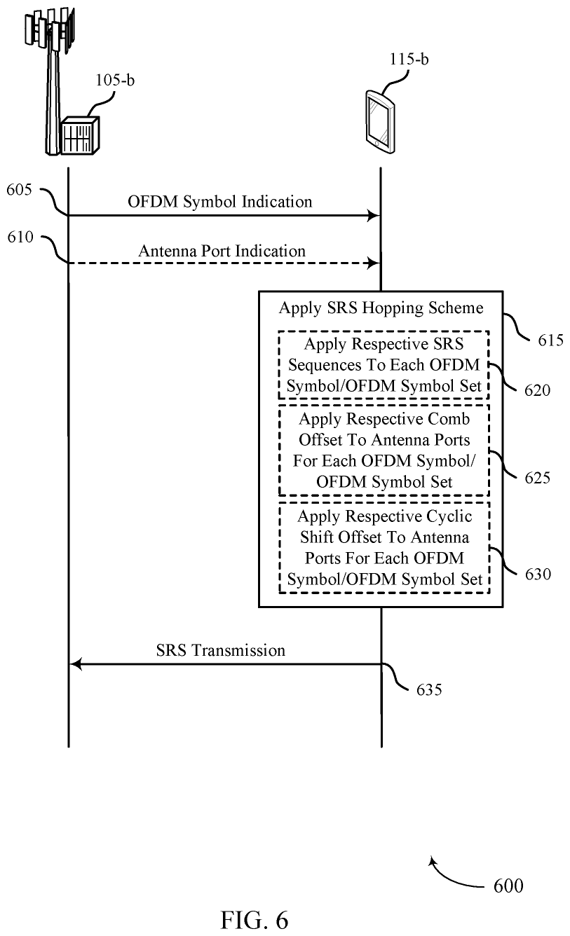

FIG. 6 shows an example of a process flow 600 that supports multiple antenna port SRS transmission using sets of symbols in accordance with one or more aspects of the present disclosure. The process flow 600 may be implemented by aspects of the wireless communications system 100, the wireless communications system 200, the resource diagram 300-a, the resource diagram 300-b, the resource diagram 400-a, the resource diagram 400-b, the resource diagram 500-a, and the resource diagram 500-b. For example, the process flow 600 may illustrate a UE 115-b communicating with a network entity 105-b, where the UE 115-b and the network entity 105-b may be examples of corresponding devices described herein, including with reference to FIGS. 1 and 2. In some aspects, the process flow 600 may support techniques for applying an SRS hopping scheme to a multiple antenna port transmission using sets of symbols.

In the following description of the process flow 600, the operations may be performed in a different order than the order shown. Specific operations also may be left out of the process flow 600, or other operations may be added to the process flow 600. Further, although some operations or signaling may be shown to occur at different times for discussion purposes, these operations may actually occur at the same time.

At 605, the UE 115-b may receive signaling indicating a numerical quantity of OFDM symbols, L, in respective OFDM symbol sets in an SRS resource. Each OFDM symbol in an OFDM symbol set may be assigned a portion of the antenna ports assigned to an SRS resource (e.g., the OFDM symbol set), the numerical quantity being greater than one. The signaling may be a DCI message, RRC signaling, a MAC-CE, or any other control signaling.

In some cases, at 610, the UE 115-b may receive signaling indicating a numerical quantity of antenna ports for an SRS. The signaling may be the same signaling as the signaling indicating the numerical quantity of OFDM symbols, or may be different signaling.

At 615, the UE 115-b may apply an SRS hopping scheme to an SRS transmission.

For example, at 620, the UE 115-b may apply a different SRS sequence to respective set of OFDM symbols in accordance with the SRS hopping scheme (e.g., on a per OFDM symbol set basis), where sequence hopping is enabled at the UE 115-b. In some other examples, the UE 115-b may apply a different SRS sequence to each OFDM symbol in accordance with the SRS hopping scheme (e.g., on a per OFDM symbol basis), where sequence hopping is enabled at the UE 115-b.

In some other examples, at 625, the UE 115-b may apply a comb offset to the antenna ports of an SRS resource, or OFDM symbol set, in accordance with the SRS hopping scheme, where comb offset hopping is enabled at the UE 115-b. In some cases, the UE 115-b may apply a comb offset to respective antenna ports for each OFDM symbol in accordance with the SRS hopping scheme, where comb offset hopping is enabled at the UE 115-b.

In some other examples, at 630, the UE 115-b may apply a cyclic shift offset to antenna ports of an SRS resource, or OFDM symbol set, in accordance with the SRS hopping scheme, where cyclic shift hopping is enabled at the UE 115-b. In some cases, the UE 115-b may apply a cyclic shift offset to respective antenna ports for each OFDM symbol in accordance with the SRS hopping scheme, where cyclic shift hopping is enabled at the UE 115-b.

At 635, the UE 115-b may transmit the SRS using one or more SRS resources and the hopping scheme. Additionally, or alternatively, the UE 115-b may transmit the SRS in accordance with a power normalization factor. The UE 115-b may obtain, or calculate, the power normalization factor based on an inverse square root of the numerical quantity of OFDM symbols and the numerical quantity of antenna ports.

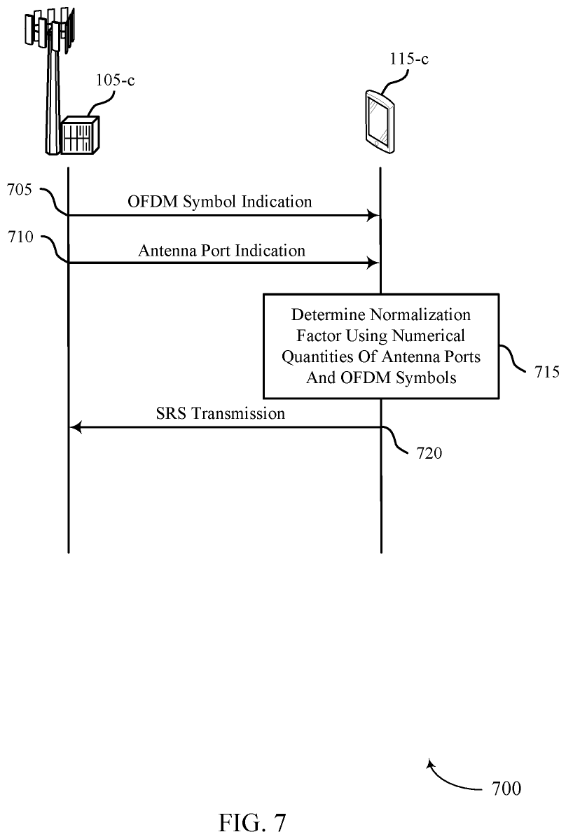

FIG. 7 shows an example of a process flow 700 that supports multiple antenna port SRS transmission using sets of symbols in accordance with one or more aspects of the present disclosure. The process flow 700 may be implemented by aspects of the wireless communications system 100, the wireless communications system 200, the resource diagram 300-a, the resource diagram 300-b, the resource diagram 400-a, the resource diagram 400-b, the resource diagram 500-a, and the resource diagram 500-b. For example, the process flow 700 may illustrate a UE 115-c communicating with a network entity 105-c, where the UE 115-c and the network entity 105-c may be examples of corresponding devices described herein, including with reference to FIGS. 1 and 2. In some aspects, the process flow 700 may support techniques for applying a power normalization factor to a multiple antenna port transmission using sets of symbols.

In the following description of the process flow 700, the operations may be performed in a different order than the order shown. Specific operations also may be left out of the process flow 700, or other operations may be added to the process flow 700. Further, although some operations or signaling may be shown to occur at different times for discussion purposes, these operations may actually occur at the same time.

At 705, the UE 115-c may receive signaling indicating a numerical quantity of OFDM symbols, L, in respective OFDM symbol sets in an SRS resource. Each OFDM symbol in an OFDM symbol set may be assigned a portion of the antenna ports assigned to an SRS resource (e.g., the OFDM symbol set), the numerical quantity being greater than one. The signaling may be a DCI message, RRC signaling, a MAC-CE, or any other control signaling.

In some cases, at 710, the UE 115-c may receive signaling indicating a numerical quantity of antenna ports for an SRS. The signaling may be the same signaling as the signaling indicating the numerical quantity of OFDM symbols, or may be different signaling.

At 715, the UE 115-c may determine a power normalization factor using the numerical quantity of OFDM symbols and the numerical quantity of antenna ports. In some examples, as a total quantity of antenna ports may be mapped to L OFDM symbols in an OFDM symbol set, the power normalization factor per OFDM symbol may be

$$\sqrt{\frac{1}{( {N}_{ap} / L )}} = \sqrt{\frac{L}{{N}_{ap}}} .$$

The UE 115-c may use equation 4 to calculate the power normalization factor.

At 720, the UE 115-c may transmit the SRS using the SRS resource in accordance with the power normalization factor.

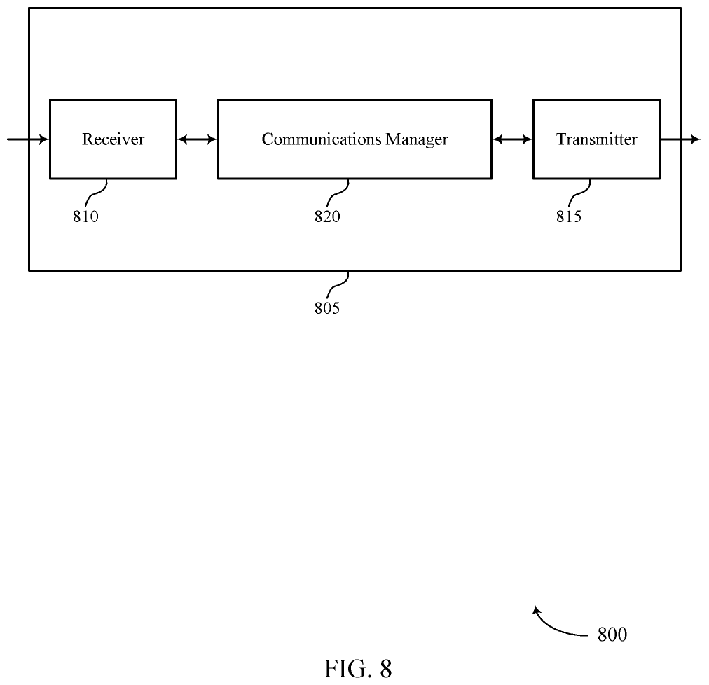

FIG. 8 shows a block diagram 800 of a device 805 that supports multiple antenna port SRS transmission using sets of symbols in accordance with one or more aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to multiple antenna port SRS transmission using sets of symbols). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to multiple antenna port SRS transmission using sets of symbols). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of multiple antenna port SRS transmission using sets of symbols as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), a graphics processing unit (GPU), a neural processing unit (NPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software) executed by a processor. If implemented in code executed by a processor, the functions of the communications manager 820, the receiver 810, the transmitter 815, or various combinations or components thereof may be performed by a general-purpose processor, a DSP, a CPU, a GPU, a NPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a UE in accordance with examples as disclosed herein. For example, the communications manager 820 is capable of, configured to, or operable to support a means for receiving first signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of a set of multiple antenna ports associated with the respective set of OFDM symbols, the numerical quantity being greater than one. The communications manager 820 is capable of, configured to, or operable to support a means for transmitting an SRS using the SRS resource in accordance with an SRS hopping scheme associated with the numerical quantity of OFDM symbols.

Additionally, or alternatively, the communications manager 820 may support wireless communications at a UE in accordance with examples as disclosed herein. For example, the communications manager 820 is capable of, configured to, or operable to support a means for receiving first signaling indicating a numerical quantity of antenna ports of a set of multiple antenna ports associated with an SRS. The communications manager 820 is capable of, configured to, or operable to support a means for receiving second signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of the set of multiple antenna ports, the numerical quantity of OFDM symbols being greater than one. The communications manager 820 is capable of, configured to, or operable to support a means for transmitting the SRS using the SRS resource in accordance with a power normalization factor that is based on the numerical quantity of antenna ports and the numerical quantity of OFDM symbols.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for applying an SRS hopping scheme, a power normalization factor, or both to a multiple antenna port transmission using sets of symbols, which may provide for reduced processing, reduced power consumption, more efficient utilization of communication resources, or any combination thereof.

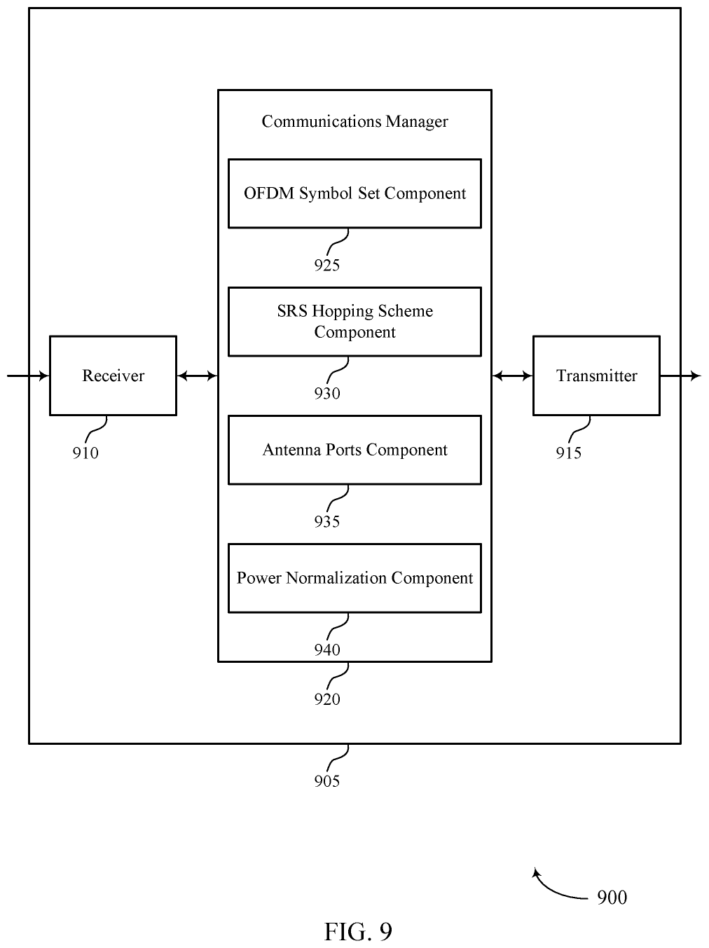

FIG. 9 shows a block diagram 900 of a device 905 that supports multiple antenna port SRS transmission using sets of symbols in accordance with one or more aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to multiple antenna port SRS transmission using sets of symbols). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to multiple antenna port SRS transmission using sets of symbols). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of multiple antenna port SRS transmission using sets of symbols as described herein. For example, the communications manager 920 may include an OFDM symbol set component 925, an SRS hopping scheme component 930, an antenna ports component 935, a power normalization component 940, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a UE in accordance with examples as disclosed herein. The OFDM symbol set component 925 is capable of, configured to, or operable to support a means for receiving first signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of a set of multiple antenna ports associated with the respective set of OFDM symbols, the numerical quantity being greater than one. The SRS hopping scheme component 930 is capable of, configured to, or operable to support a means for transmitting an SRS using the SRS resource in accordance with an SRS hopping scheme associated with the numerical quantity of OFDM symbols.

Additionally, or alternatively, the communications manager 920 may support wireless communications at a UE in accordance with examples as disclosed herein. The antenna ports component 935 is capable of, configured to, or operable to support a means for receiving first signaling indicating a numerical quantity of antenna ports of a set of multiple antenna ports associated with an SRS. The OFDM symbol set component 925 is capable of, configured to, or operable to support a means for receiving second signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of the set of multiple antenna ports, the numerical quantity of OFDM symbols being greater than one. The power normalization component 940 is capable of, configured to, or operable to support a means for transmitting the SRS using the SRS resource in accordance with a power normalization factor that is based on the numerical quantity of antenna ports and the numerical quantity of OFDM symbols.

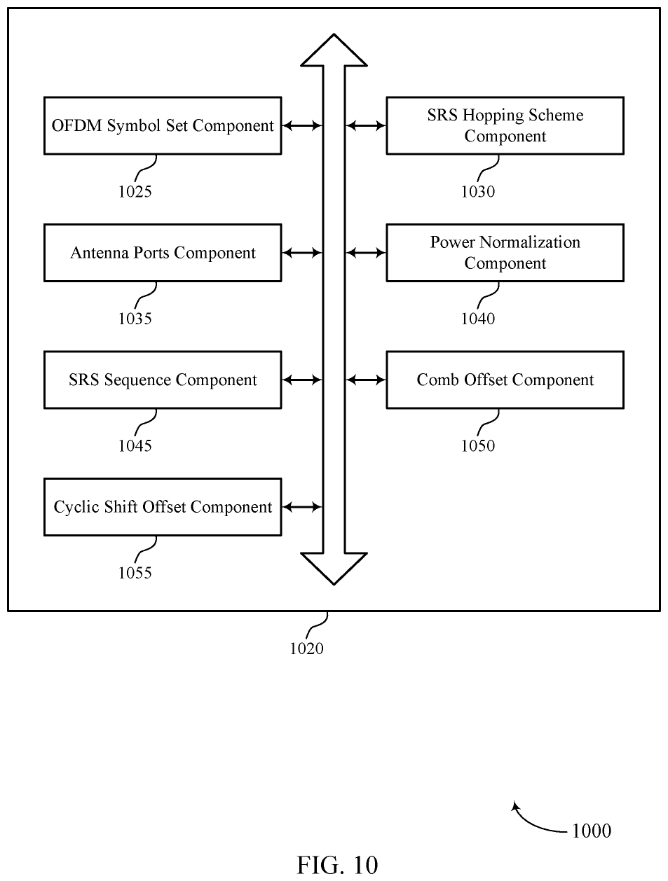

FIG. 10 shows a block diagram 1000 of a communications manager 1020 that supports multiple antenna port SRS transmission using sets of symbols in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of multiple antenna port SRS transmission using sets of symbols as described herein. For example, the communications manager 1020 may include an OFDM symbol set component 1025, an SRS hopping scheme component 1030, an antenna ports component 1035, a power normalization component 1040, an SRS sequence component 1045, a comb offset component 1050, a cyclic shift offset component 1055, or any combination thereof. Each of these components may communicate, directly or indirectly, with one another (e.g., via one or more buses).

The communications manager 1020 may support wireless communications at a UE in accordance with examples as disclosed herein. The OFDM symbol set component 1025 is capable of, configured to, or operable to support a means for receiving first signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of a set of multiple antenna ports associated with the respective set of OFDM symbols, the numerical quantity being greater than one. The SRS hopping scheme component 1030 is capable of, configured to, or operable to support a means for transmitting an SRS using the SRS resource in accordance with an SRS hopping scheme associated with the numerical quantity of OFDM symbols.

In some examples, the SRS sequence component 1045 is capable of, configured to, or operable to support a means for applying a different SRS sequence to the each respective set of OFDM symbols in accordance with the SRS hopping scheme, where sequence hopping is enabled at the UE.

In some examples, the SRS sequence component 1045 is capable of, configured to, or operable to support a means for applying a different SRS sequence to each OFDM symbol of the set of multiple sets of OFDM symbols in accordance with the SRS hopping scheme, where sequence hopping is enabled at the UE.

In some examples, the comb offset component 1050 is capable of, configured to, or operable to support a means for applying a comb offset to the set of multiple antenna ports in accordance with the SRS hopping scheme, where comb offset hopping is enabled at the UE.

In some examples, the comb offset component 1050 is capable of, configured to, or operable to support a means for applying a comb offset to the portion of antenna ports in accordance with the SRS hopping scheme, where comb offset hopping is enabled at the UE.

In some examples, the cyclic shift offset component 1055 is capable of, configured to, or operable to support a means for applying a cyclic shift offset to the set of multiple antenna ports in accordance with the SRS hopping scheme, where cyclic shift hopping is enabled at the UE.

In some examples, the cyclic shift offset component 1055 is capable of, configured to, or operable to support a means for applying a cyclic shift offset to the portion of antenna ports in accordance with the SRS hopping scheme, where cyclic shift hopping is enabled at the UE.

In some examples, the antenna ports component 1035 is capable of, configured to, or operable to support a means for receiving second signaling indicating a numerical quantity of antenna ports associated with an SRS, where the SRS is transmitted in accordance with a power normalization factor that is based on a relationship between the numerical quantity of antenna ports and the numerical quantity of OFDM symbols.

Additionally, or alternatively, the communications manager 1020 may support wireless communications at a UE in accordance with examples as disclosed herein. The antenna ports component 1035 is capable of, configured to, or operable to support a means for receiving first signaling indicating a numerical quantity of antenna ports of a set of multiple antenna ports associated with an SRS. In some examples, the OFDM symbol set component 1025 is capable of, configured to, or operable to support a means for receiving second signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of the set of multiple antenna ports, the numerical quantity of OFDM symbols being greater than one. The power normalization component 1040 is capable of, configured to, or operable to support a means for transmitting the SRS using the SRS resource in accordance with a power normalization factor that is based on the numerical quantity of antenna ports and the numerical quantity of OFDM symbols.

In some examples, the power normalization factor is based on an inverse square root relationship between the numerical quantity of antenna ports and the numerical quantity of OFDM symbols.

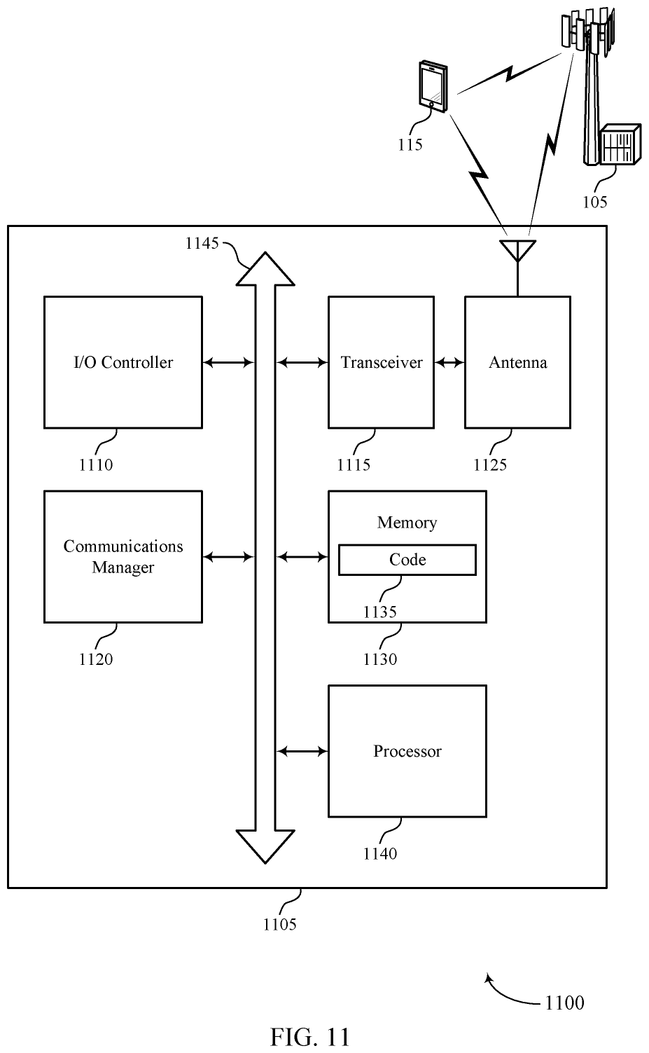

FIG. 11 shows a diagram of a system 1100 including a device 1105 that supports multiple antenna port SRS transmission using sets of symbols in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically, logically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a GPU, a NPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting multiple antenna port SRS transmission using sets of symbols). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communications at a UE in accordance with examples as disclosed herein. For example, the communications manager 1120 is capable of, configured to, or operable to support a means for receiving first signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of a set of multiple antenna ports associated with the respective set of OFDM symbols, the numerical quantity being greater than one. The communications manager 1120 is capable of, configured to, or operable to support a means for transmitting an SRS using the SRS resource in accordance with an SRS hopping scheme associated with the numerical quantity of OFDM symbols.

Additionally, or alternatively, the communications manager 1120 may support wireless communications at a UE in accordance with examples as disclosed herein. For example, the communications manager 1120 is capable of, configured to, or operable to support a means for receiving first signaling indicating a numerical quantity of antenna ports of a set of multiple antenna ports associated with an SRS. The communications manager 1120 is capable of, configured to, or operable to support a means for receiving second signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of the set of multiple antenna ports, the numerical quantity of OFDM symbols being greater than one. The communications manager 1120 is capable of, configured to, or operable to support a means for transmitting the SRS using the SRS resource in accordance with a power normalization factor that is based on the numerical quantity of antenna ports and the numerical quantity of OFDM symbols.

By including or configuring the communications manager 1120 in accordance with examples as described herein, the device 1105 may support techniques for applying an SRS hopping scheme, a power normalization factor, or both to a multiple antenna port transmission using sets of symbols, which may provide for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 (e.g., directly, indirectly, after pre-processing, without pre-processing) to cause the device 1105 to perform various aspects of multiple antenna port SRS transmission using sets of symbols as described herein, or the processor 1140 and the memory 1130 may be otherwise configured to perform or support such operations.

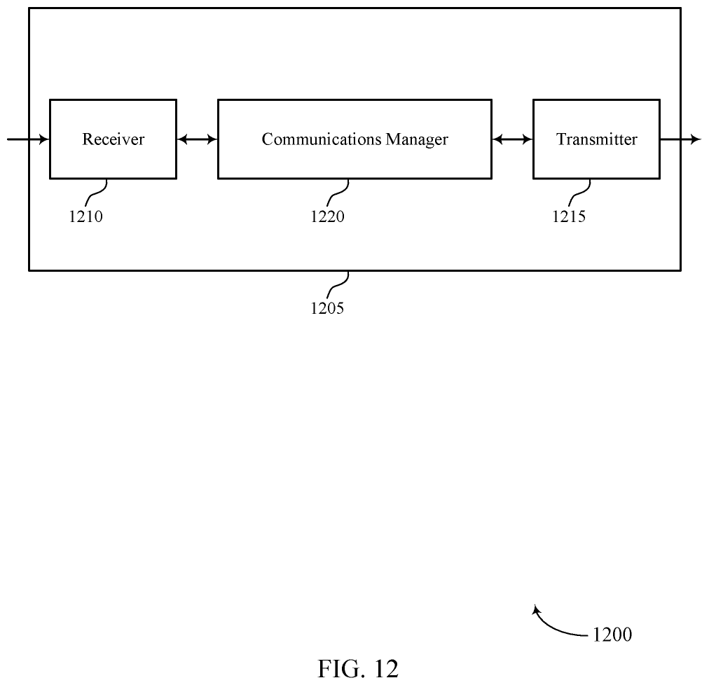

FIG. 12 shows a block diagram 1200 of a device 1205 that supports multiple antenna port SRS transmission using sets of symbols in accordance with one or more aspects of the present disclosure. The device 1205 may be an example of aspects of a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of multiple antenna port SRS transmission using sets of symbols as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, a CPU, a GPU, a NPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1220, the receiver 1210, the transmitter 1215, or various combinations or components thereof may be implemented in code (e.g., as communications management software) executed by a processor. If implemented in code executed by a processor, the functions of the communications manager 1220, the receiver 1210, the transmitter 1215, or various combinations or components thereof may be performed by a general-purpose processor, a DSP, a CPU, a GPU, a NPU, an ASIC, an FPGA, a microcontroller, or any combination of these or other programmable logic devices (e.g., configured as or otherwise supporting a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a network entity in accordance with examples as disclosed herein. For example, the communications manager 1220 is capable of, configured to, or operable to support a means for transmitting first signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of a set of multiple antenna ports associated with the respective set of OFDM symbols, the numerical quantity being greater than one. The communications manager 1220 is capable of, configured to, or operable to support a means for receiving an SRS using the SRS resource in accordance with an SRS hopping scheme associated with the numerical quantity of OFDM symbols.

Additionally, or alternatively, the communications manager 1220 may support wireless communications at a network entity in accordance with examples as disclosed herein. For example, the communications manager 1220 is capable of, configured to, or operable to support a means for transmitting first signaling indicating a numerical quantity of antenna ports of a set of multiple antenna ports associated with an SRS. The communications manager 1220 is capable of, configured to, or operable to support a means for transmitting second signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of the set of multiple antenna ports, the numerical quantity of OFDM symbols being greater than one. The communications manager 1220 is capable of, configured to, or operable to support a means for receiving the SRS using the SRS resource in accordance with a power normalization factor that is based on the numerical quantity of antenna ports and the numerical quantity of OFDM symbols.

By including or configuring the communications manager 1220 in accordance with examples as described herein, the device 1205 (e.g., a processor controlling or otherwise coupled with the receiver 1210, the transmitter 1215, the communications manager 1220, or a combination thereof) may support techniques for applying an SRS hopping scheme, a power normalization factor, or both to a multiple antenna port transmission using sets of symbols, which may provide for reduced processing, reduced power consumption, more efficient utilization of communication resources, or any combination thereof.

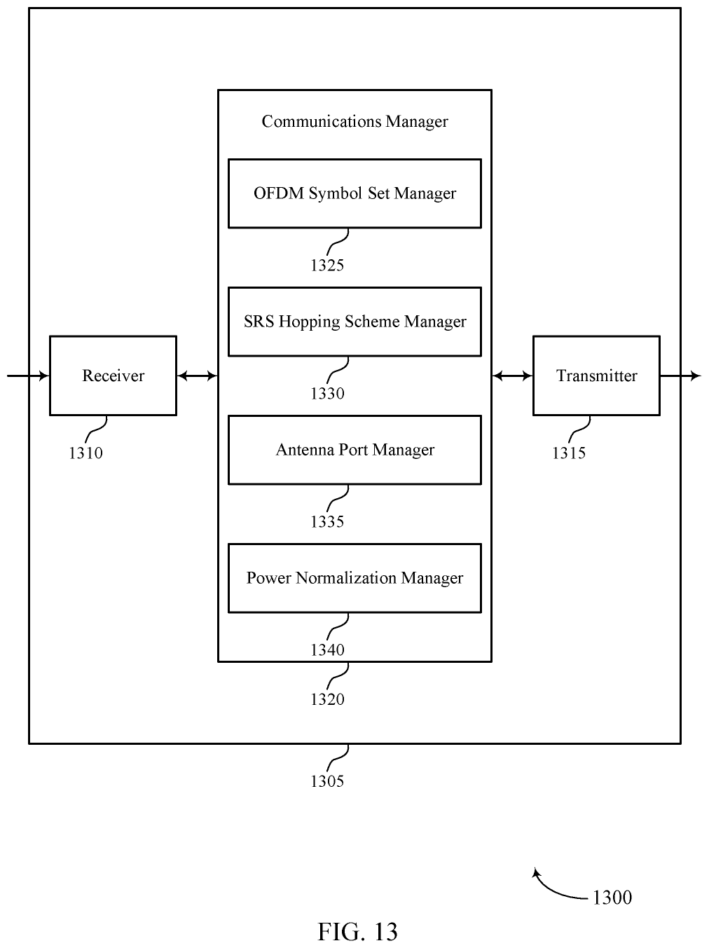

FIG. 13 shows a block diagram 1300 of a device 1305 that supports multiple antenna port SRS transmission using sets of symbols in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of multiple antenna port SRS transmission using sets of symbols as described herein. For example, the communications manager 1320 may include an OFDM symbol set manager 1325, an SRS hopping scheme manager 1330, an antenna port manager 1335, a power normalization manager 1340, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications at a network entity in accordance with examples as disclosed herein. The OFDM symbol set manager 1325 is capable of, configured to, or operable to support a means for transmitting first signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of a set of multiple antenna ports associated with the respective set of OFDM symbols, the numerical quantity being greater than one. The SRS hopping scheme manager 1330 is capable of, configured to, or operable to support a means for receiving an SRS using the SRS resource in accordance with an SRS hopping scheme associated with the numerical quantity of OFDM symbols.

Additionally, or alternatively, the communications manager 1320 may support wireless communications at a network entity in accordance with examples as disclosed herein. The antenna port manager 1335 is capable of, configured to, or operable to support a means for transmitting first signaling indicating a numerical quantity of antenna ports of a set of multiple antenna ports associated with an SRS. The OFDM symbol set manager 1325 is capable of, configured to, or operable to support a means for transmitting second signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of the set of multiple antenna ports, the numerical quantity of OFDM symbols being greater than one. The power normalization manager 1340 is capable of, configured to, or operable to support a means for receiving the SRS using the SRS resource in accordance with a power normalization factor that is based on the numerical quantity of antenna ports and the numerical quantity of OFDM symbols.

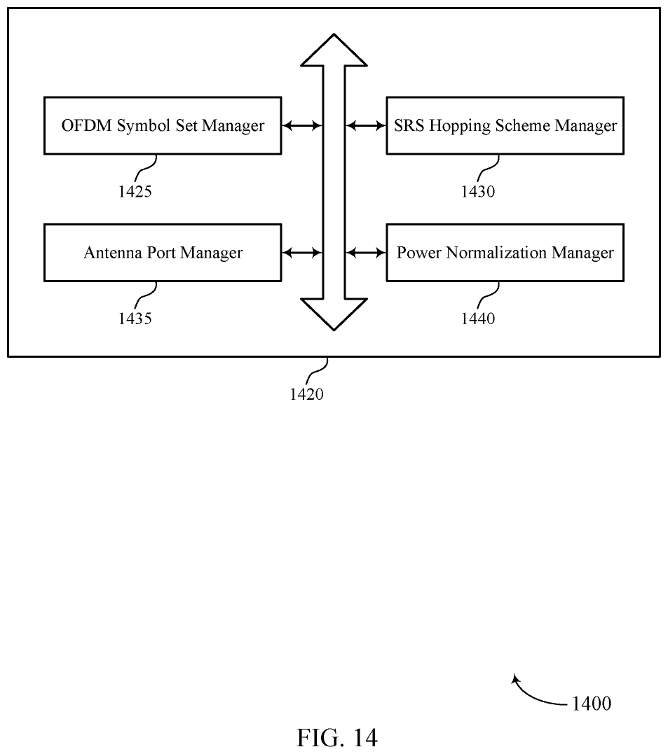

FIG. 14 shows a block diagram 1400 of a communications manager 1420 that supports multiple antenna port SRS transmission using sets of symbols in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of multiple antenna port SRS transmission using sets of symbols as described herein. For example, the communications manager 1420 may include an OFDM symbol set manager 1425, an SRS hopping scheme manager 1430, an antenna port manager 1435, a power normalization manager 1440, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communications at a network entity in accordance with examples as disclosed herein. The OFDM symbol set manager 1425 is capable of, configured to, or operable to support a means for transmitting first signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of a set of multiple antenna ports associated with the respective set of OFDM symbols, the numerical quantity being greater than one. The SRS hopping scheme manager 1430 is capable of, configured to, or operable to support a means for receiving an SRS using the SRS resource in accordance with an SRS hopping scheme associated with the numerical quantity of OFDM symbols.

In some examples, a different SRS sequence is applied to each of the respective set of OFDM symbols in accordance with the SRS hopping scheme.

In some examples, a different SRS sequence is applied to each OFDM symbol of the set of multiple sets of OFDM symbols in accordance with the SRS hopping scheme.

In some examples, a comb offset is applied to the set of multiple antenna ports in accordance with the SRS hopping scheme.

In some examples, a comb offset is applied to the portion of antenna ports in accordance with the SRS hopping scheme.

In some examples, a cyclic shift offset is applied to the set of multiple antenna ports in accordance with the SRS hopping scheme.

In some examples, a cyclic shift offset is applied to the portion of antenna ports in accordance with the SRS hopping scheme.

In some examples, the antenna port manager 1435 is capable of, configured to, or operable to support a means for transmitting second signaling indicating a numerical quantity of antenna ports associated with an SRS, where the SRS is received in accordance with a power normalization factor that is based on a relationship between the numerical quantity of antenna ports and the numerical quantity of OFDM symbols.

Additionally, or alternatively, the communications manager 1420 may support wireless communications at a network entity in accordance with examples as disclosed herein. The antenna port manager 1435 is capable of, configured to, or operable to support a means for transmitting first signaling indicating a numerical quantity of antenna ports of a set of multiple antenna ports associated with an SRS. In some examples, the OFDM symbol set manager 1425 is capable of, configured to, or operable to support a means for transmitting second signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of the set of multiple antenna ports, the numerical quantity of OFDM symbols being greater than one. The power normalization manager 1440 is capable of, configured to, or operable to support a means for receiving the SRS using the SRS resource in accordance with a power normalization factor that is based on the numerical quantity of antenna ports and the numerical quantity of OFDM symbols.

In some examples, the power normalization factor is based on an inverse square root relationship between the numerical quantity of antenna ports and the numerical quantity of OFDM symbols.

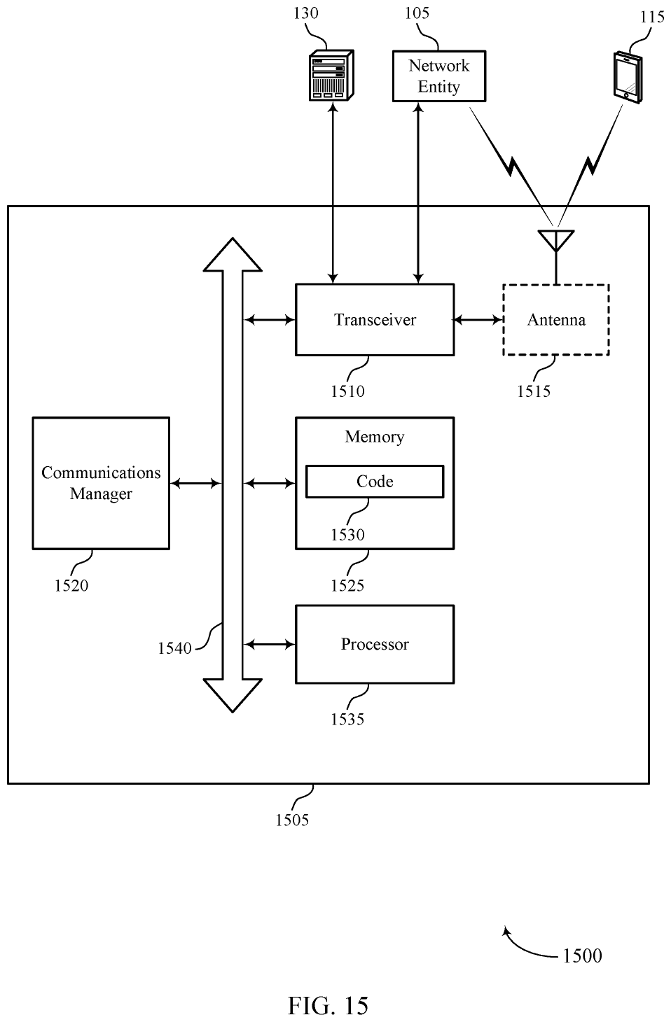

FIG. 15 shows a diagram of a system 1500 including a device 1505 that supports multiple antenna port SRS transmission using sets of symbols in accordance with one or more aspects of the present disclosure. The device 1505 may be an example of or include the components of a device 1205, a device 1305, or a network entity 105 as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, a memory 1525, code 1530, and a processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or memory components (for example, the processor 1535, or the memory 1525, or both), may be included in a chip or chip assembly that is installed in the device 1505. In some examples, the transceiver may be operable to support communications via one or more communications links (e.g., a communication link 125, a backhaul communication link 120, a midhaul communication link 162, a fronthaul communication link 168).

The memory 1525 may include RAM and ROM. The memory 1525 may store computer-readable, computer-executable code 1530 including instructions that, when executed by the processor 1535, cause the device 1505 to perform various functions described herein. The code 1530 may be stored in a non-transitory computer-readable medium such as system memory or another type of memory. In some cases, the code 1530 may not be directly executable by the processor 1535 but may cause a computer (e.g., when compiled and executed) to perform functions described herein. In some cases, the memory 1525 may contain, among other things, a BIOS which may control basic hardware or software operation such as the interaction with peripheral components or devices.

The processor 1535 may include an intelligent hardware device (e.g., a general-purpose processor, a DSP, an ASIC, a CPU, a GPU, a NPU, an FPGA, a microcontroller, a programmable logic device, discrete gate or transistor logic, a discrete hardware component, or any combination thereof). In some cases, the processor 1535 may be configured to operate a memory array using a memory controller. In some other cases, a memory controller may be integrated into the processor 1535. The processor 1535 may be configured to execute computer-readable instructions stored in a memory (e.g., the memory 1525) to cause the device 1505 to perform various functions (e.g., functions or tasks supporting multiple antenna port SRS transmission using sets of symbols). For example, the device 1505 or a component of the device 1505 may include a processor 1535 and memory 1525 coupled with the processor 1535, the processor 1535 and memory 1525 configured to perform various functions described herein. The processor 1535 may be an example of a cloud-computing platform (e.g., one or more physical nodes and supporting software such as operating systems, virtual machines, or container instances) that may host the functions (e.g., by executing code 1530) to perform the functions of the device 1505. The processor 1535 may be any one or more suitable processors capable of executing scripts or instructions of one or more software programs stored in the device 1505 (such as within the memory 1525). In some implementations, the processor 1535 may be a component of a processing system. A processing system may generally refer to a system or series of machines or components that receives inputs and processes the inputs to produce a set of outputs (which may be passed to other systems or components of, for example, the device 1505). For example, a processing system of the device 1505 may refer to a system including the various other components or subcomponents of the device 1505, such as the processor 1535, or the transceiver 1510, or the communications manager 1520, or other components or combinations of components of the device 1505. The processing system of the device 1505 may interface with other components of the device 1505, and may process information received from other components (such as inputs or signals) or output information to other components. For example, a chip or modem of the device 1505 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1505 may transmit information output from the chip or modem. Additionally, or alternatively, in some implementations, the one or more interfaces may refer to an interface between the processing system of the chip or modem and a receiver, such that the device 1505 may obtain information or signal inputs, and the information may be passed to the processing system. A person having ordinary skill in the art will readily recognize that a first interface also may obtain information or signal inputs, and a second interface also may output information or signal outputs.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the memory 1525, the code 1530, and the processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

The communications manager 1520 may support wireless communications at a network entity in accordance with examples as disclosed herein. For example, the communications manager 1520 is capable of, configured to, or operable to support a means for transmitting first signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of a set of multiple antenna ports associated with the respective set of OFDM symbols, the numerical quantity being greater than one. The communications manager 1520 is capable of, configured to, or operable to support a means for receiving an SRS using the SRS resource in accordance with an SRS hopping scheme associated with the numerical quantity of OFDM symbols.

Additionally, or alternatively, the communications manager 1520 may support wireless communications at a network entity in accordance with examples as disclosed herein. For example, the communications manager 1520 is capable of, configured to, or operable to support a means for transmitting first signaling indicating a numerical quantity of antenna ports of a set of multiple antenna ports associated with an SRS. The communications manager 1520 is capable of, configured to, or operable to support a means for transmitting second signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of the set of multiple antenna ports, the numerical quantity of OFDM symbols being greater than one. The communications manager 1520 is capable of, configured to, or operable to support a means for receiving the SRS using the SRS resource in accordance with a power normalization factor that is based on the numerical quantity of antenna ports and the numerical quantity of OFDM symbols.

By including or configuring the communications manager 1520 in accordance with examples as described herein, the device 1505 may support techniques for applying an SRS hopping scheme, a power normalization factor, or both to a multiple antenna port transmission using sets of symbols, which may provide for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, the processor 1535, the memory 1525, the code 1530, or any combination thereof. For example, the code 1530 may include instructions executable by the processor 1535 (e.g., directly, indirectly, after pre-processing, without pre-processing) to cause the device 1505 to perform various aspects of multiple antenna port SRS transmission using sets of symbols as described herein, or the processor 1535 and the memory 1525 may be otherwise configured to perform or support such operations.

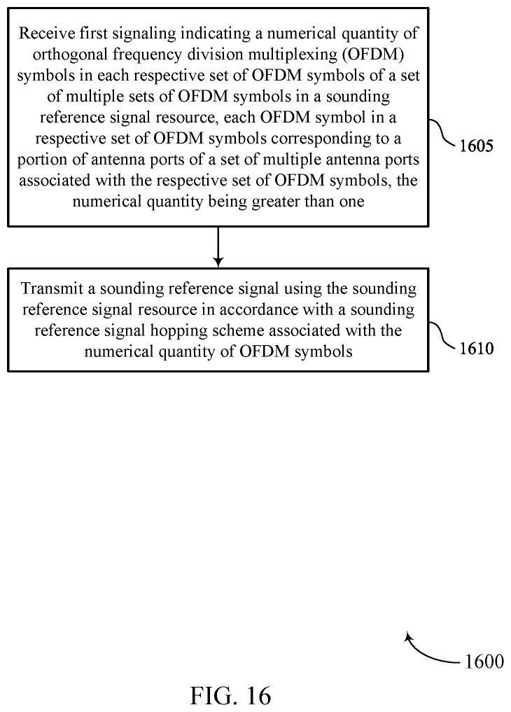

FIG. 16 shows a flowchart illustrating a method 1600 that supports multiple antenna port SRS transmission using sets of symbols in accordance with aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the wireless UE to perform the described functions. Additionally, or alternatively, the wireless UE may perform aspects of the described functions using special-purpose hardware.

At 1605, the method may include receiving first signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of a set of multiple antenna ports associated with the respective set of OFDM symbols, the numerical quantity being greater than one. The operations of 1605 may be performed in accordance with examples as disclosed herein. In some examples, aspects of the operations of 1605 may be performed by an OFDM symbol set component 1025 as described with reference to FIG. 10.

At 1610, the method may include transmitting an SRS using the SRS resource in accordance with an SRS hopping scheme associated with the numerical quantity of OFDM symbols. The operations of 1610 may be performed in accordance with examples as disclosed herein. In some examples, aspects of the operations of 1610 may be performed by an SRS hopping scheme component 1030 as described with reference to FIG. 10.

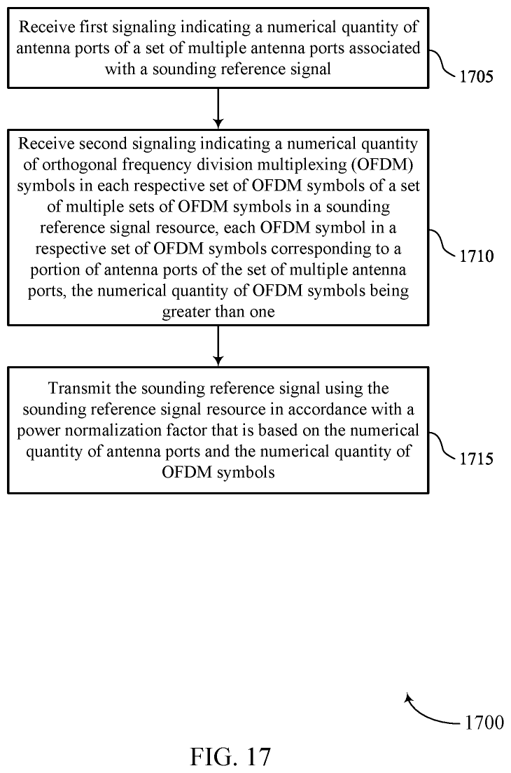

FIG. 17 shows a flowchart illustrating a method 1700 that supports multiple antenna port SRS transmission using sets of symbols in accordance with aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the wireless UE to perform the described functions. Additionally, or alternatively, the wireless UE may perform aspects of the described functions using special-purpose hardware.

At 1705, the method may include receiving first signaling indicating a numerical quantity of antenna ports of a set of multiple antenna ports associated with an SRS. The operations of 1705 may be performed in accordance with examples as disclosed herein. In some examples, aspects of the operations of 1705 may be performed by an antenna ports component 1035 as described with reference to FIG. 10.

At 1710, the method may include receiving second signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of the set of multiple antenna ports, the numerical quantity of OFDM symbols being greater than one. The operations of 1710 may be performed in accordance with examples as disclosed herein. In some examples, aspects of the operations of 1710 may be performed by an OFDM symbol set component 1025 as described with reference to FIG. 10.

At 1715, the method may include transmitting the SRS using the SRS resource in accordance with a power normalization factor that is based on the numerical quantity of antenna ports and the numerical quantity of OFDM symbols. The operations of 1715 may be performed in accordance with examples as disclosed herein. In some examples, aspects of the operations of 1715 may be performed by a power normalization component 1040 as described with reference to FIG. 10.

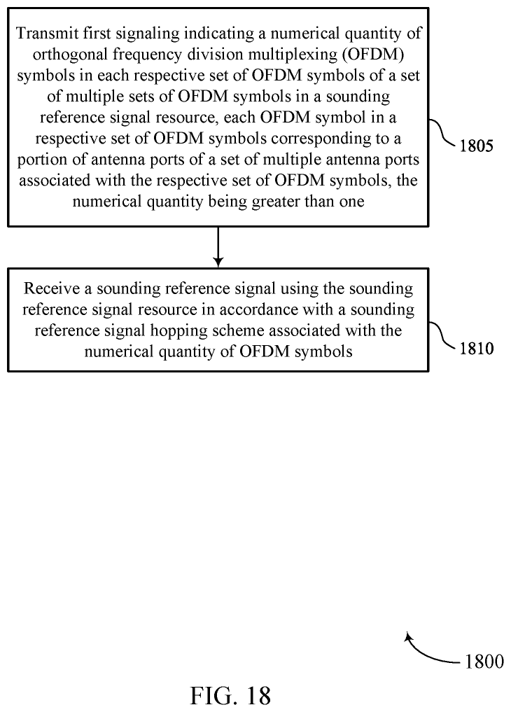

FIG. 18 shows a flowchart illustrating a method 1800 that supports multiple antenna port SRS transmission using sets of symbols in accordance with aspects of the present disclosure. The operations of the method 1800 may be implemented by a network entity or its components as described herein. For example, the operations of the method 1800 may be performed by a network entity as described with reference to FIGS. 1 through 7 and 12 through 15. In some examples, a network entity may execute a set of instructions to control the functional elements of the wireless network entity to perform the described functions. Additionally, or alternatively, the wireless network entity may perform aspects of the described functions using special-purpose hardware.

At 1805, the method may include transmitting first signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of a set of multiple antenna ports associated with the respective set of OFDM symbols, the numerical quantity being greater than one. The operations of 1805 may be performed in accordance with examples as disclosed herein. In some examples, aspects of the operations of 1805 may be performed by an OFDM symbol set manager 1425 as described with reference to FIG. 14.

At 1810, the method may include receiving an SRS using the SRS resource in accordance with an SRS hopping scheme associated with the numerical quantity of OFDM symbols. The operations of 1810 may be performed in accordance with examples as disclosed herein. In some examples, aspects of the operations of 1810 may be performed by an SRS hopping scheme manager 1430 as described with reference to FIG. 14.

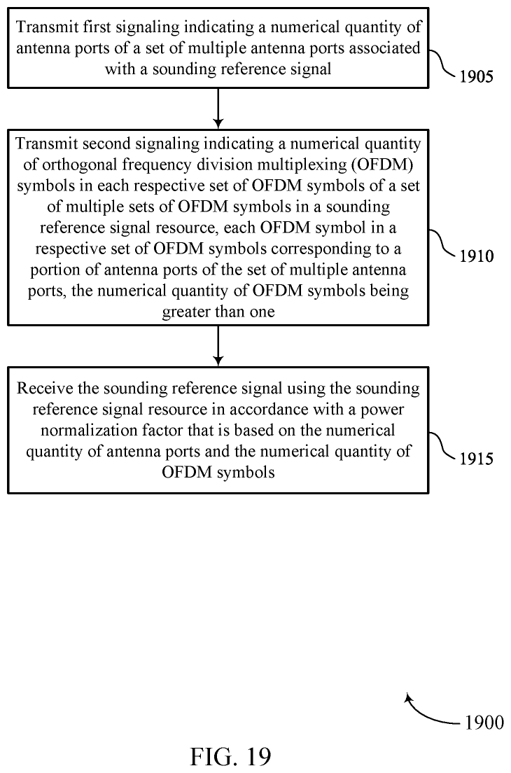

FIG. 19 shows a flowchart illustrating a method 1900 that supports multiple antenna port SRS transmission using sets of symbols in accordance with aspects of the present disclosure. The operations of the method 1900 may be implemented by a network entity or its components as described herein. For example, the operations of the method 1900 may be performed by a network entity as described with reference to FIGS. 1 through 7 and 12 through 15. In some examples, a network entity may execute a set of instructions to control the functional elements of the wireless network entity to perform the described functions. Additionally, or alternatively, the wireless network entity may perform aspects of the described functions using special-purpose hardware.

At 1905, the method may include transmitting first signaling indicating a numerical quantity of antenna ports of a set of multiple antenna ports associated with an SRS. The operations of 1905 may be performed in accordance with examples as disclosed herein. In some examples, aspects of the operations of 1905 may be performed by an antenna port manager 1435 as described with reference to FIG. 14.

At 1910, the method may include transmitting second signaling indicating a numerical quantity of OFDM symbols in each respective set of OFDM symbols of a set of multiple sets of OFDM symbols in an SRS resource, each OFDM symbol in a respective set of OFDM symbols corresponding to a portion of antenna ports of the set of multiple antenna ports, the numerical quantity of OFDM symbols being greater than one. The operations of 1910 may be performed in accordance with examples as disclosed herein. In some examples, aspects of the operations of 1910 may be performed by an OFDM symbol set manager 1425 as described with reference to FIG. 14.

At 1915, the method may include receiving the SRS using the SRS resource in accordance with a power normalization factor that is based on the numerical quantity of antenna ports and the numerical quantity of OFDM symbols. The operations of 1915 may be performed in accordance with examples as disclosed herein. In some examples, aspects of the operations of 1915 may be performed by a power normalization manager 1440 as described with reference to FIG. 14.

The following provides an overview of aspects of the present disclosure:

Aspect 1: A method for wireless communications at a UE, comprising: receiving first signaling indicating a numerical quantity of orthogonal frequency division multiplexing (OFDM) symbols in each respective set of OFDM symbols of a plurality of sets of OFDM symbols in a sounding reference signal resource, each OFDM symbol in a respective set of OFDM symbols corresponding to a portion of antenna ports of a plurality of antenna ports associated with the respective set of OFDM symbols, the numerical quantity being greater than one; and transmitting a sounding reference signal using the sounding reference signal resource in accordance with a sounding reference signal hopping scheme associated with the numerical quantity of OFDM symbols.

Aspect 2: The method of aspect 1, further comprising: applying a different sounding reference signal sequence to the each respective set of OFDM symbols in accordance with the sounding reference signal hopping scheme, wherein sequence hopping is enabled at the UE.

Aspect 3: The method of aspect 1, further comprising: applying a different sounding reference signal sequence to each OFDM symbol of the plurality of sets of OFDM symbols in accordance with the sounding reference signal hopping scheme, wherein sequence hopping is enabled at the UE.

Aspect 4: The method of any of aspects 1 through 3, further comprising: applying a comb offset to the plurality of antenna ports in accordance with the sounding reference signal hopping scheme, wherein comb offset hopping is enabled at the UE.

Aspect 5: The method of any of aspects 1 through 3, further comprising: applying a comb offset to the portion of antenna ports in accordance with the sounding reference signal hopping scheme, wherein comb offset hopping is enabled at the UE.

Aspect 6: The method of any of aspects 1 through 5, further comprising: applying a cyclic shift offset to the plurality of antenna ports in accordance with the sounding reference signal hopping scheme, wherein cyclic shift hopping is enabled at the UE.

Aspect 7: The method of any of aspects 1 through 5, further comprising: applying a cyclic shift offset to the portion of antenna ports in accordance with the sounding reference signal hopping scheme, wherein cyclic shift hopping is enabled at the UE.

Aspect 8: The method of any of aspects 1 through 7, further comprising: receiving second signaling indicating a numerical quantity of antenna ports associated with a sounding reference signal, wherein the sounding reference signal is transmitted in accordance with a power normalization factor that is based at least in part on a relationship between the numerical quantity of antenna ports and the numerical quantity of OFDM symbols.

Aspect 9: A method for wireless communications at a UE, comprising: receiving first signaling indicating a numerical quantity of antenna ports of a plurality of antenna ports associated with a sounding reference signal; receiving second signaling indicating a numerical quantity of orthogonal frequency division multiplexing (OFDM) symbols in each respective set of OFDM symbols of a plurality of sets of OFDM symbols in a sounding reference signal resource, each OFDM symbol in a respective set of OFDM symbols corresponding to a portion of antenna ports of the plurality of antenna ports, the numerical quantity of OFDM symbols being greater than one; and transmitting the sounding reference signal using the sounding reference signal resource in accordance with a power normalization factor that is based at least in part on the numerical quantity of antenna ports and the numerical quantity of OFDM symbols.

Aspect 10: The method of aspect 9, wherein the power normalization factor is based at least in part on an inverse square root relationship between the numerical quantity of antenna ports and the numerical quantity of OFDM symbols.

Aspect 11: A method for wireless communications at a network entity, comprising: transmitting first signaling indicating a numerical quantity of orthogonal frequency division multiplexing (OFDM) symbols in each respective set of OFDM symbols of a plurality of sets of OFDM symbols in a sounding reference signal resource, each OFDM symbol in a respective set of OFDM symbols corresponding to a portion of antenna ports of a plurality of antenna ports associated with the respective set of OFDM symbols, the numerical quantity being greater than one; and receiving a sounding reference signal using the sounding reference signal resource in accordance with a sounding reference signal hopping scheme associated with the numerical quantity of OFDM symbols.

Aspect 12: The method of aspect 11, wherein a different sounding reference signal sequence is applied to each of the respective set of OFDM symbols in accordance with the sounding reference signal hopping scheme.

Aspect 13: The method of aspect 11, wherein a different sounding reference signal sequence is applied to each OFDM symbol of the plurality of sets of OFDM symbols in accordance with the sounding reference signal hopping scheme.

Aspect 14: The method of any of aspects 11 through 13, wherein a comb offset is applied to the plurality of antenna ports in accordance with the sounding reference signal hopping scheme.

Aspect 15: The method of any of aspects 11 through 13, wherein a comb offset is applied to the portion of antenna ports in accordance with the sounding reference signal hopping scheme.

Aspect 16: The method of any of aspects 11 through 15, wherein a cyclic shift offset is applied to the plurality of antenna ports in accordance with the sounding reference signal hopping scheme.

Aspect 17: The method of any of aspects 11 through 15, wherein a cyclic shift offset is applied to the portion of antenna ports in accordance with the sounding reference signal hopping scheme.

Aspect 18: The method of any of aspects 11 through 17, further comprising: transmitting second signaling indicating a numerical quantity of antenna ports associated with a sounding reference signal, wherein the sounding reference signal is received in accordance with a power normalization factor that is based at least in part on a relationship between the numerical quantity of antenna ports and the numerical quantity of OFDM symbols.

Aspect 19: A method for wireless communications at a network entity, comprising: transmitting first signaling indicating a numerical quantity of antenna ports of a plurality of antenna ports associated with a sounding reference signal; transmitting second signaling indicating a numerical quantity of orthogonal frequency division multiplexing (OFDM) symbols in each respective set of OFDM symbols of a plurality of sets of OFDM symbols in a sounding reference signal resource, each OFDM symbol in a respective set of OFDM symbols corresponding to a portion of antenna ports of the plurality of antenna ports, the numerical quantity of OFDM symbols being greater than one; and receiving the sounding reference signal using the sounding reference signal resource in accordance with a power normalization factor that is based at least in part on the numerical quantity of antenna ports and the numerical quantity of OFDM symbols.

Aspect 20: The method of aspect 19, wherein the power normalization factor is based at least in part on an inverse square root relationship between the numerical quantity of antenna ports and the numerical quantity of OFDM symbols.

Aspect 21: An apparatus for wireless communications at a UE, comprising a processor and memory coupled with the at least one processor, the memory storing instructions executable by the at least one processor to perform a method of any of aspects 1 through 8, 33, or any combination thereof.

Aspect 22: An apparatus for wireless communications at a UE, comprising at least one means for performing a method of any of aspects 1 through 8, 33, or any combination thereof.

Aspect 23: A non-transitory computer-readable medium storing code for wireless communications at a UE, the code comprising instructions executable by at least one processor to perform a method of any of aspects 1 through 8, 33, or any combination thereof.

Aspect 24: An apparatus for wireless communications at a UE, comprising a processor and memory coupled with the at least one processor, the memory storing instructions executable by the at least one processor to perform a method of any of aspects 9 through 10.

Aspect 25: An apparatus for wireless communications at a UE, comprising at least one means for performing a method of any of aspects 9 through 10.

Aspect 26: A non-transitory computer-readable medium storing code for wireless communications at a UE, the code comprising instructions executable by at least one processor to perform a method of any of aspects 9 through 10.

Aspect 27: An apparatus for wireless communications at a network entity, comprising a processor; memory coupled with the processor, the memory storing instructions executable by the at least one processor to cause the apparatus to perform a method of any of aspects 11 through 18, 34, or any combination thereof.

Aspect 28: An apparatus for wireless communications at a network entity, comprising at least one means for performing a method of any of aspects 11 through 18 and 34.

Aspect 29: A non-transitory computer-readable medium storing code for wireless communications at a network entity, the code comprising instructions executable by at least one processor to perform a method of any of aspects 11 through 18, 34, or any combination thereof.

Aspect 30: An apparatus for wireless communications at a network entity, comprising at least one processor and memory coupled with the at least one processor; and instructions stored in the memory and executable by the processor to cause the apparatus to perform a method of any of aspects 19 through 20.

Aspect 31: An apparatus for wireless communications at a network entity, comprising at least one means for performing a method of any of aspects 19 through 20.

Aspect 32: A non-transitory computer-readable medium storing code for wireless communications at a network entity, the code comprising instructions executable by at least one processor to perform a method of any of aspects 19 through 20.

Aspect 33: The method of any of aspects 1 through 8, wherein frequency resources for the sounding reference signal in the sounding reference signal resource are the same across OFDM symbols within a respective set of OFDM signals.

Aspect 34: The method of any of aspects 11 through 18, wherein frequency resources for the sounding reference signal in the sounding reference signal resource are the same across OFDM symbols within a respective set of OFDM signals.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein. Components within a wireless communication system may be coupled (for example, operatively, communicatively, functionally, electronically, and/or electrically) to each other.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, a NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
at least one processor; and
memory coupled with the at least one processor, the memory storing instructions executable by the at least one processor to cause the UE to:
receive first signaling indicating a numerical quantity of orthogonal frequency division multiplexing (OFDM) symbols in each respective set of OFDM symbols of a plurality of sets of OFDM symbols in a sounding reference signal resource, each OFDM symbol in each respective set of OFDM symbols corresponding to a portion of antenna ports of a plurality of antenna ports associated with the respective set of OFDM symbols, the numerical quantity being greater than one; and
transmit a sounding reference signal using the sounding reference signal resource in accordance with a sounding reference signal hopping scheme associated with the numerical quantity of OFDM symbols.

2. The apparatus of claim 1, wherein the instructions are further executable by the at least one processor to cause the apparatus to:
apply a different sounding reference signal sequence to each OFDM symbol of the plurality of sets of OFDM symbols in accordance with the sounding reference signal hopping scheme, wherein sequence hopping is enabled at the UE.

3. The apparatus of claim 2, wherein frequency resources for the sounding reference signal in the sounding reference signal resource are the same across OFDM symbols within a respective set of OFDM signals.

4. The apparatus of claim 1, wherein the instructions are further executable by the at least one processor to cause the apparatus to:
apply a different sounding reference signal sequence to the each respective set of OFDM symbols in accordance with the sounding reference signal hopping scheme, wherein sequence hopping is enabled at the UE.

5. The apparatus of claim 1, wherein the instructions are further executable by the at least one processor to cause the apparatus to:
apply a comb offset to the plurality of antenna ports in accordance with the sounding reference signal hopping scheme, wherein comb offset hopping is enabled at the UE.

6. The apparatus of claim 1, wherein the instructions are further executable by the at least one processor to cause the apparatus to:
apply a comb offset to the portion of antenna ports in accordance with the sounding reference signal hopping scheme, wherein comb offset hopping is enabled at the UE.

7. The apparatus of claim 1, wherein the instructions are further executable by the at least one processor to cause the apparatus to:
apply a cyclic shift offset to the plurality of antenna ports in accordance with the sounding reference signal hopping scheme, wherein cyclic shift hopping is enabled at the UE.

8. The apparatus of claim 1, wherein the instructions are further executable by the at least one processor to cause the apparatus to:
apply a cyclic shift offset to the portion of antenna ports in accordance with the sounding reference signal hopping scheme, wherein cyclic shift hopping is enabled at the UE.

9. The apparatus of claim 1, wherein the instructions are further executable by the at least one processor to cause the apparatus to:
receive second signaling indicating a numerical quantity of antenna ports associated with a sounding reference signal, wherein the sounding reference signal is transmitted in accordance with a power normalization factor that is based at least in part on a relationship between the numerical quantity of antenna ports and the numerical quantity of OFDM symbols.

10. An apparatus for wireless communications at a user equipment (UE), comprising:
at least one processor; and
memory coupled with the at least one processor, the memory storing instructions executable by the at least one processor to cause the UE to:
receive first signaling indicating a numerical quantity of antenna ports of a plurality of antenna ports associated with a sounding reference signal;
receive second signaling indicating a numerical quantity of orthogonal frequency division multiplexing (OFDM) symbols in each respective set of OFDM symbols of a plurality of sets of OFDM symbols in a sounding reference signal resource, each OFDM symbol in each respective set of OFDM symbols corresponding to a portion of antenna ports of the plurality of antenna ports, the numerical quantity of OFDM symbols being greater than one; and
transmit the sounding reference signal using the sounding reference signal resource in accordance with a power normalization factor that is based at least in part on the numerical quantity of antenna ports and the numerical quantity of OFDM symbols.

11. The apparatus of claim 10, wherein the power normalization factor is based at least in part on an inverse square root relationship between the numerical quantity of antenna ports and the numerical quantity of OFDM symbols.

12. An apparatus for wireless communications at a network entity, comprising:
at least one processor; and
memory coupled with the at least one processor, the memory storing instructions executable by the at least one processor to cause the network entity to:
transmit first signaling indicating a numerical quantity of orthogonal frequency division multiplexing (OFDM) symbols in each respective set of OFDM symbols of a plurality of sets of OFDM symbols in a sounding reference signal resource, each OFDM symbol in each respective set of OFDM symbols corresponding to a portion of antenna ports of a plurality of antenna ports associated with the respective set of OFDM symbols, the numerical quantity being greater than one; and
receive a sounding reference signal using the sounding reference signal resource in accordance with a sounding reference signal hopping scheme associated with the numerical quantity of OFDM symbols.

13. The apparatus of claim 12, wherein a different sounding reference signal sequence is applied to each OFDM symbol of the plurality of sets of OFDM symbols in accordance with the sounding reference signal hopping scheme.

14. The apparatus of claim 13, wherein frequency resources for the sounding reference signal in the sounding reference signal resource are the same across OFDM symbols within a respective set of OFDM signals.

15. The apparatus of claim 12, wherein a different sounding reference signal sequence is applied to each of the respective set of OFDM symbols in accordance with the sounding reference signal hopping scheme.

16. The apparatus of claim 12, wherein a comb offset is applied to the plurality of antenna ports in accordance with the sounding reference signal hopping scheme.

17. The apparatus of claim 12, wherein a comb offset is applied to the portion of antenna ports in accordance with the sounding reference signal hopping scheme.

18. The apparatus of claim 12, wherein a cyclic shift offset is applied to the plurality of antenna ports in accordance with the sounding reference signal hopping scheme.

19. The apparatus of claim 12, wherein a cyclic shift offset is applied to the portion of antenna ports in accordance with the sounding reference signal hopping scheme.

20. The apparatus of claim 12, wherein the instructions are further executable by the at least one processor to cause the apparatus to:
transmit second signaling indicating a numerical quantity of antenna ports associated with a sounding reference signal, wherein the sounding reference signal is received in accordance with a power normalization factor that is based at least in part on a relationship between the numerical quantity of antenna ports and the numerical quantity of OFDM symbols.

21. An apparatus for wireless communications at a network entity, comprising:
at least one processor; and
memory coupled with the at least one processor, the memory storing instructions executable by the at least one processor to cause the network entity to:
transmit first signaling indicating a numerical quantity of antenna ports of a plurality of antenna ports associated with a sounding reference signal;
transmit second signaling indicating a numerical quantity of orthogonal frequency division multiplexing (OFDM) symbols in each respective set of OFDM symbols of a plurality of sets of OFDM symbols in a sounding reference signal resource, each OFDM symbol in each respective set of OFDM symbols corresponding to a portion of antenna ports of the plurality of antenna ports, the numerical quantity of OFDM symbols being greater than one; and
receive the sounding reference signal using the sounding reference signal resource in accordance with a power normalization factor that is based at least in part on the numerical quantity of antenna ports and the numerical quantity of OFDM symbols.

22. The apparatus of claim 21, wherein the power normalization factor is based at least in part on an inverse square root relationship between the numerical quantity of antenna ports and the numerical quantity of OFDM symbols.
